(19) United States
(12) Patent Application Publication
(10) Pub. No.: US 2005/0137368 A1
(43) Pub. Date: Jun. 23, 2005

(54) Radiation tolerant copolymers

(76) Inventors: Weqing Weng, Houston, TX (US); Srivatsan Srinivas, Pearland, TX (US); Anthony George Karandinos, St. Stevens-Woluwe (BE)

Correspondence Address: ExxonMobil Chemical Company;Law Technology, P.O. Box 2149, Baytown, TX, 77522-2149, US

(21) Appl. No.: 10/738,784

(22) Filed: Dec. 17, 2003

(51) Int. Cl. C08F 4/44

(52) U.S. Cl. 526/170; 526/160; 526/943; 526/348.2; 526/348.6

(57) ABSTRACT

Disclosed herein is a copolymer comprising the polymerization product of propylene and a branched olefin, the copolymer comprising about 80 to about 99.9 wt % propylene; about 0.1 to about 20 wt % branched olefin; and the copolymer having a weight average molecular weigh of about 80,000 to about 800,000 Daltons, wherein a weight average molecular weight of the copolymer after being irradiated at a dosage of at least about 5 kGy is greater than or equal to about 90% the weight average molecular weight of the copolymer prior to being irradiated. Uses of the copolymer and a process of making the copolymer are also disclosed.

### FIELD OF THE INVENTION

This invention relates generally to olefinic polymers. More particularly, this invention relates to a copolymer comprising propylene in combination with one or more branched olefinic components, and having enhanced radiation tolerance. Uses of such heat and/or radiation tolerant copolymers are also disclosed.

### BACKGROUND OF THE INVENTION

Polypropylene is an excellent material for use in a variety of applications. Polypropylene is shatter resistant, has resistance to a number of chemical agents, is inexpensive, is relatively easily formed and handled, and may be incinerated and/or recycled. However, polypropylene is subject to various limitations. Polypropylene materials may be cloudy or translucent rather than clear, polypropylene may soften and deform when sterilized at high temperature by steam and/or may yellow and/or become brittle when treated with high energy radiation, particularly beta and gamma radiation as used for example in sterilization.

Sterilization using radiation (i.e., radiation sterilization) is useful in providing sterile medical instruments, appliances, devices, and/or supplies. Beta radiation from an electron beam, or gamma radiation from a cobalt-60 (Co⁶⁰) source, is often used to sterilize medical equipment. Such radiation treatments are a particularly convenient means of sterilizing various items, since the items may be packed in bulk, or in individually sealed clean packages, and then irradiated after packaging. Such sterilization treatments yield sterile instruments and devices without the need for special handling or repackaging after sterilization, helping to enhance patient safety.

However, polypropylene may degrade when exposed to radiation at levels consistent with radiation sterilization. For example, polypropylene may become brittle, change color, and/or undergo other physical changes which render the material unfit for a particular purpose. Accordingly, such sterilization treatments may be inappropriate for medical instruments, appliances, devices, and/or supplies comprising polypropylene components, and/or packaged within polypropylene. The inability of polypropylene to undergo radiation sterilization acts to severely limit the use of polypropylene in medical and other areas requiring sterilization.

The potential usefulness of polypropylene has been recognized for some time. Attempts to overcome the limitations of polypropylene include U.S. Pat. No. 4,110,185, directed to the use of a non-crystalline mobilizing agent in polypropylene formulations to increase the free volume of the polymer and prevent radiation embrittlement. U.S. Pat. No. 4,845,137 directed to a polypropylene composition which is stable to sterilizing radiation, comprising polypropylene of narrow MWD, a liquid mobilizing additive, a hindered amine compound, and a clarifying agent. While such additives may appear to enhance radiation-tolerance of polypropylene, mobilizing additives tend to be oily or greasy and thus, can contribute to processing difficulties and product flaws.

Other attempts to overcome the limitations of polypropylene include EP-A2-0 431 475, directed to a radiation resistant polypropylene resin composition suitable for the preparation of molded articles in which physical properties “scarcely deteriorate during sterilization by radiation” by utilizing substantially syndiotactic polypropylene. The composition may also include a phosphorous containing anti-oxidant, an amine containing antioxidant, and a nucleating agent.

JP 04-214709 is directed to ethylene/propylene copolymers with at least 50% syndiotacticity, which have improved radiation tolerance. Such copolymers are produced by specific chiral metallocene-type catalysis and are preferably compounded with phosphorous or amine-containing antioxidants for best radiation tolerance.

U.S. Pat. No. 5,340,848 is directed to a radiation resistant polypropylene resin composition comprising a polypropylene having a substantially syndiotactic structure with optional anti-oxidants and/or nucleating agents.

WO 92/14784 is directed to blends of from 30 to 40 weight percent ethylene-based copolymer with 70 to 30 weight percent propylene-based copolymer for use in heat seal applications.

U.S. Pat. No. 6,231,936 is directed to an article of manufacture which has been exposed to radiation sufficient for sterilization, comprising a blend of from about 50 to about 99 wt % polypropylene with from about 1 to about 50 wt % polyethylene, said polyethylene having a molecular weight distribution between about 1 and about 4, and a composition distribution breadth index greater than about 45% wherein the amount of polyethylene present in the blend is sufficient to increase the radiation tolerance of the article over that of the polypropylene alone.

Accordingly, a need exists for a simple, cost effective system to provide radiation tolerant polypropylene. Ideally, such a polypropylene composition would provide products that are essentially transparent (i.e., clear) and that would be dimensionally stable at elevated temperatures. Such products could optionally be subjected to sterilization by means other than radiation without softening or deformation or significant deterioration of optical properties. It would be of further benefit if the polymer used for forming various articles would not tend to foul molding or forming equipment with, for example, oil or grease. Users of the final formed products, as well as makers of such articles would benefit if such polymer compounds would not exude oil or grease from the surface of molded parts. Such articles would be particularly attractive to the medical and food packaging industries.

### SUMMARY OF THE INVENTION

In one aspect of the present invention a copolymer comprises the polymerization product of propylene and a branched olefin, the copolymer comprising about 80 to about 99.9 wt % propylene; about 0.1 to about 20 wt % branched olefin; and the copolymer having a weight average molecular weigh of about 80,000 to about 800,000 Daltons, wherein a weight average molecular weight of the copolymer after being irradiated at a dosage of at least about 5 kGy is greater than or equal to about 90% the weight average molecular weight of the copolymer prior to being irradiated.

In another aspect of the present invention, a copolymer comprises the polymerization product of propylene and a branched olefin, the copolymer comprising about 90 to about 99 wt % propylene; about 1 to about 10 wt % of a branched olefin; less than or equal to about 5 wt % linear alpha olefin; the copolymer fuirther having a weight average molecular weight of about 150,000 to about 600,000 Daltons; a ratio of a weight average molecular weight to a number average molecular weigh of less than or equal to about 3; a composition distribution breadth index of greater than or equal to about 60; a Young's Modulus according to ASTM-D1708 of greater than or equal to about 585 MPa; a yield stress according to ASTM-D1708 of greater than or equal to about 20 MPa; and a break strain according to ASTM-D1708 of greater than or equal to about 200%, wherein and the copolymer, after being irradiated at a dosage of about 20 kGy has a break strain of greater than or equal to about 100%; a break strain of greater than or equal to about 80% the break strain of the copolymer prior to being irradiated at a dosage of about 20 kGy; and a weight average molecular weight of greater than or equal to about 80% the weight average molecular weight of the copolymer prior to being irradiated at a dosage of about 20 kGy.

In yet another aspect of the present invention a process to produce a copolymer comprises the steps of contacting propylene and one or more branched olefins with a metallocene catalyst, and collecting the copolymer, wherein the copolymer comprises about 80 to about 99.9 wt % propylene; about 0. 1 to about 20 wt % branched olefin, wherein the copolymer has a weight average molecular weigh of about 80,000 to about 800,000 Daltons, and wherein after the copolymer has been irradiated at a dosage of at least about 5 kGy to produce an irradiated copolymer, the irradiated copolymer has a weight average molecular weight greater than or equal to about 90% the weight average molecular weight of the copolymer prior to being irradiated at a dosage of at least about 5 kGy.

### DETAILED DESCRIPTION OF THE INVENTION

The present invention is directed to a polymer comprising propylene monomer having improved radiation tolerance. In particular, a copolymer comprising propylene and one or more branched olefinic monomers. The resulting copolymers have enhanced tolerance to radiation, heat, and have better clarity than do other polypropylene and polypropylene blends. These copolymers are useful in medical applications, food packaging, and related applications.

As used herein, the term “radiation tolerant” refers to a material being resistant to deterioration in mechanical properties, clarity, color, and/or other physical and chemical properties observed in certain materials such as polypropylene, when these materials are subjected to radiation. In particular, radiation tolerant materials are resistant to deterioration in various properties when irradiated at levels and/or doses greater than or equal to those useful in radiation sterilization treatments. Also, as used herein, by an “irradiated” material (e.g., polymer, copolymer, article, and the like) it is meant a material that has been exposed to a radiation source for a period of time to produce levels of radiation at or above those consistent with sterilization procedures. For purposes herein, an irradiated material may include a material that has been exposed to a radiation source under conditions sufficient to impart at least about 5 kGy to the material as a time weighted average. For example, materials may be irradiated through exposure of the material to a Co⁶⁰ irradiation source capable of producing about 6 KGy/hour. Sample may also be subject to an accelerated aging protocol, which may include exposure of the samples at 60° C. for 21 days. The specimens are then examined by various ASTM test methods.

Of course, the acceptable level of radiation tolerance depends, at least in part, upon the application or end-use of the irradiated material. For example, in applications requiring very stiff, clear, and visually appealing articles, (e.g., having structural integrity, being essentially transparent, and without being substantially yellowed in color) a smaller deterioration in properties may render the article useless, while other applications might be more forgiving, allowing for greater deterioration of various properties while still being suitable for the intended purpose.

As used herein, the term “thermally tolerant” refers to a material being resistant to deterioration in mechanical properties, clarity, color, and/or other properties typically experienced by certain materials, such as polypropylene, when subjected to temperatures greater than or equal to about 225° C. As with radiation tolerance, the acceptable level of thermal tolerance depends, at least in part, upon the application or end-use of the material

For the purposes of this invention and the claims thereto, when a polymer is referred to as comprising an olefin, the olefin present in the polymer is the polymerized form of the olefin. The term copolymer is meant to include polymers comprising at least two monomeric species. Accordingly, a copolymer comprising polypropylene may comprise propylene having incorporated therein a single, or a plurality of other monomers within the copolymer. A catalytically active material may be interchangeably referred to as a catalytic material, or as a catalyst. A catalyst system comprises a catalyst, an activator when appropriate, and optionally a support. A reactor is any container(s) in which a chemical reaction occurs. In addition, the numbering scheme for the Periodic Table Groups used herein are as described in CHEMICAL AND ENGINEERING NEWS, 63(5), 27 (1985). Temperatures are listed in degrees Celsius (° C.) unless otherwise noted.

By branched olefinic monomer, it is meant a non-linear monomer component comprising a carbon-carbon double bond. Accordingly, branched olefinic monomers include non-linear alpha olefins, cyclic olefins, aromatic olefins, substituted aromatic olefins, and the like, which are further described herein.

Further, for purposes of this invention, Me is methyl, Ph is phenyl, Et is ethyl, Pr is propyl, iPr is isopropyl, n-Pr is normal propyl, Bu is butyl, iBu is isobutyl, tBu is tertiary butyl, p-tBu is para-tertiary butyl, TMS is trimethylsilyl, a per fluoro radical is an organic radical having one or more available hydrogen atoms substituted with fluorine atoms.

Various copolymers comprising propylene may be useful in medical applications which do not require the materials to undergo radiation sterilization. For example, propylene-ethylene random copolymers (RCP) may be used where clarity, low melting point, and/or low modulus is desired, such as in a film, fiber, and in injection molded devices. The presence of ethylene comonomers in an RCP is thought to disrupt the regularity in the backbone of the polypropylene, thereby lowering the crystallinity. As a result, RCP's may have lower melting points, lower modulus, and higher clarity along with improved impact properties over propylene alone.

Random copolymers having propylene and higher alpha olefins may also show improvements over propylene alone. For example, U.S. Pat. No. 5,336,746 is directed to a propylene random copolymer composed of structural units (a) derived from propylene and structural units (b) derived from alpha-olefin of 4 to 20 carbon atoms, the improvement which comprises that the propylene random copolymer has: (i) the structural units of polypropylene in an amount of 90 to 99 mol % and the structural units derived from alpha olefins in an amount of 1 to 10 mol %, (ii) an intrinsic viscosity (Ti) as measured in decahydronaphthalene at 135° C. of 0.5 to 6 dl/g, (iii) a melting point (Tm) as measured by a differential scanning calorimeter falling with in the range of 90<Tm<155-3.5 (100-P), wherein P is the propylene content (mol %) present in the copolymer, (iv) a ratio (Mw/Mn) of a weight average molecular weight (Mw) to a number average molecular weight (Mn) as measured by gel permeation chromatography of less than 3.5, and (v) a boiling trichloroethylene-insoluble content of less than 5% by weight. In addition, patent application WO97/19991 is directed to articles made from propylene-higher alpha olefin random copolymers having improved cold flow resistance and creep resistance. However, such RCP's may have poor radiation resistance.

Without wishing to be bound by theory, it is possible that tertiary carbon atoms in the RCP polymer backbone may be prone to radical attack, which may occur during radiation sterilization. This radical attack of these tertiary carbons is thought to result in RCP degradation upon radiation sterilization. The end result is a lessening of physical and mechanical properties of an RCP after radiation treatment.

It has been unexpectedly discovered that branched olefinic components, in particular branched alpha olefins, cyclic olefins, aromatic olefins, in combination with propylene, produce a copolymer having improved thermal and radiation tolerance over polypropylene alone. The branched olefin comonomers of the present invention are thought to reduce radical attack on the tertiary carbon atoms in the polymer backbone. Accordingly, disclosed herein is a copolymer comprising polypropylene, having an improved tolerance to radiation sterilization, and/or an improved thermal tolerance over other propylene polymers and copolymers.

Preferably, the present invention provides a commercially useful means of imparting radiation tolerance to polypropylene compositions without significantly affecting the clarity or the processability of such polypropylene compositions. Blends of polypropylene and traditional, Ziegler-Natta-produced polyethylene may tend to produce cloudy or hazy films and articles. The present invention, on the other hand, allows for the production of radiation tolerant films and articles that exhibit excellent optical properties. In fact, it is has surprisingly been discovered that branched olefinic monomers, and in particular branched alpha olefins, could be incorporated in the amounts disclosed herein without severely diminishing the optical and other properties of the polypropylene copolymer disclosed. Also, ideally, the copolymers of the present invention are highly resistant to the softening effects of elevated temperatures. Accordingly, the present invention may find use in a medical device, in a packaging container, or the like.

Radiation Tolerant Copolymers

The copolymer comprising propylene and branched olefinic monomers (hereinafter referred to as “the PP/BO copolymer”) of the present invention preferably comprise about 80 to about 99.9 wt % polypropylene, based on the total weight of the copolymer. Within this range, a polypropylene weight percent of less than or equal to about 99 wt % can be employed, with less than or equal to about 97 wt % preferred, and less than or equal to about 95 wt % more preferred. Also preferred within this range is a polypropylene wt % greater than or equal to about 85 wt %, with greater than or equal to about 87 wt % more preferred, and greater than or equal to about 90 wt % especially preferred.

In an embodiment, the PP/BO copolymer may preferably comprise about 0.1 to about 20 wt % branched olefin, based on the total weight of the copolymer. Within this range, a branched olefin weight percent of less than or equal to about 18 wt % can be employed, with less than or equal to about 15 wt % preferred, and less than or equal to about 10 wt % more preferred. Also preferred within this range is a branched olefin wt % of greater than or equal to about 1 wt %, with greater than or equal to about 3 wt % more preferred, and greater than or equal to about 5 wt % especially preferred.

In another embodiment, the PP/BO copolymer preferably comprises less than or equal to about 10 wt % linear olefin, based on the total weight of the copolymer. Within this range, a linear olefin weight percent of less than or equal to about 8 wt % can be employed, with less than or equal to about 6 wt % preferred, and less than or equal to about 5 wt % more preferred.

In an embodiment, the weight average molecular weight (Mw) as determined using gel permeation chromatography or the like of the PP/BO copolymer may be about 80,000 to about 800,000 Daltons. Within this range, a molecular weight of less than or equal to about 750,000 Daltons can be employed, with less than or equal to about 700,000 Daltons preferred, and less than or equal to about 600,000 Daltons more preferred. Also preferred within this range is a Mw of greater than or equal to about 85,000 Daltons, with greater than or equal to about 150,000 Daltons more preferred, and greater than or equal to about 200,000 Daltons especially preferred.

In an embodiment, PP/BO copolymers having a narrow molecular weight distribution (MWD) may be preferred. By a narrow MWD, it is meant the ratio of the weight average molecular weight (Mw) to the number average molecular weight (Mn) collectively referred to herein as Mw/Mn Ratio, may be less than or equal to about 4. Within this range a Mw/Mn Ratio of less than or equal to about 3.9 can be employed, with less than or equal to about 3.5 preferred, and less than or equal to about 3 more preferred.

Preferred PP/BO copolymers may also comprise a narrower composition distribution, as compared with other polymeric materials. A useful method of measuring composition distribution is through employment of the “Composition Distribution Breadth Index” (CDBI), which is defined as the weight percent of the copolymer molecules having a comonomer content within 50% (that is 50% on each side) of the median total molar comonomer content. CDBI measurements can be made utilizing Temperature Rising Elution Fraction (TREF). The technique used herein is described by Wild et al. in the Journal of Polymer Science, Polymer Physics Edition, vol. 20, pg. 441 (1982). Further details relating to determining the CDBI of a copolymer are known to those skilled in the art. For example, PCT Patent Application WO 93/03093, published Feb. 18, 1993, and incorporated herein by reference, provides an improved means of measuring CDBI by recognizing and dealing with the low molecular weight fractions.

In an embodiment, the composition distribution breadth index of the copolymer, as determined above, may be greater than or equal to about 40, with greater than or equal to about 50 more preferred, and greater than or equal to about 60 especially preferred.

Prior to being irradiated, the Young's modulus of the copolymer, as determined according to ASTM-D1708, is preferably greater than or equal to about 480 MPa (70,000 psi), with greater than or equal to about 550 MPa (80.000 psi) more preferred, and greater than or equal to about 585 MPa (85,000 psi) especially preferred.

Prior to being irradiated, the yield stress of the copolymer, as determined according to ASTM-D1708, is preferably greater than or equal to about 17 MPa (2,500 psi), with greater than or equal to about 18 MPa (2,700 psi) more preferred, and greater than or equal to about 20 MPa (2,900 psi) especially preferred.

Prior to being irradiated, the break strain of the copolymer, as determined according to ASTM-D1708, is preferably greater than or equal to about 100%, with greater than or equal to about 200% more preferred, and greater than or equal to about 300% especially preferred.

As used herein, an irradiated copolymer is defined as a copolymer that has been exposed to a radiation source in a manner, and for a period of time such that the copolymer receives a radiation dose of greater than or equal to about 5 kGy. Preferably, an irradiated copolymer has received a radiation dose of greater than or equal to about 20 kGy, with greater than or equal to about 30 kGy more preferred, and greater than or equal to about 40 kGy especially preferred.

An irradiated copolymer of the present invention preferably has a break strain, as determined according to ASTM-D1708, of greater than or equal to about 50%, with greater than or equal to about 100% more preferred, and greater than or equal to about 150% especially preferred.

An irradiated copolymer of the present invention preferably has a change in break strain, which may be determined as a percentage based on a difference between the break strain prior to, and after being irradiated, divided by the break stain prior to being irradiated, of less than or equal to about 90%. A change in break strain after irradiation of less than or equal to about 85% may be preferred, and less than or equal to about 80% being more preferred.

An irradiated copolymer of the present invention preferably has a change in Mw, which may be determined as a percentage based on a difference between the Mw prior to, and after being irradiated, divided by the Mw prior to being irradiated, of less than or equal to about 90%. A change in Mw after irradiation of less than or equal to about 85% may be preferred, and less than or equal to about 80% being more preferred.

Accordingly, the copolymer of the present invention prior to being irradiated at a dosage greater than or equal to about 5 kGy preferably comprises:
about 80 to about 99.9 wt % propylene and/or
about 0.1 to about 20 wt % branched olefin, and/or
less than or equal to about 10 wt % linear alpha olefins, and/or
has a weight average molecular weight of about 80,000 to about 800,000 Daltons, and/or
a Mw/Mn Ratio less than or equal to about 4, and/or
a composition distribution breadth index of greater than or equal to about 40, and/or
has a Young's Modulus according to ASTM-D1708 of greater than or equal to about 480 MPa, and/or
has a yield stress according to ASTM-D1708 of greater than or equal to about 17 MPa, and/or
has a break strain according to ASTM-D1708 of greater than or equal to about 100%, and after being irradiated at a dosage of greater than or equal to about 5 kGy has:
a break strain according to ASTM-D1708 of greater than or equal to about 50%, and/or
has a difference in break strain of less than or equal to about 90%, and/or
has a change in molecular weight of less than or equal to about 90%.

Preferably, the copolymer of the present invention prior to being irradiated at a dosage greater than or equal to about 20 kGy preferably comprises:
about 90 to about 99 wt % propylene and/or
about 1 to about 10 wt % branched olefin, and/or
less than or equal to about 5 wt % linear alpha olefins, and/or
has a weight average molecular weight of about 150,000 to about 600,000 Daltons, and/or
a Mw/Mn Ratio less than or equal to about 3, and/or
a composition distribution breadth index of greater than or equal to about 60, and/or
has a Young's Modulus according to ASTM-D1708 of greater than or equal to about 585 MPa, and/or
has a yield stress according to ASTM-D1708 of greater than or equal to about 20 MPa, and/or
has a break strain according to ASTM-D1708 of greater than or equal to about 200%, and after being irradiated at a dosage of greater than or equal to about 20 kGy has:
a break strain according to ASTM-D1708 of greater than or equal to about 100%, and/or
has a difference in break strain of less than or equal to about 80%, and/or
has a change in molecular weight of less than or equal to about 80%.
   Branched Alpha Olefins

In a preferred embodiment, branched olefins comprise branched alpha olefins. Branched alpha olefins are preferably described by the formula:
H₂C═C(R¹, R²), wherein R¹ and R² independently represent hydrogen, halogen, and/or carbon containing radicals substituted on the carbon-carbon double bond (C═C), subject to the proviso that R¹ and R² collectively comprise at least 2 carbon atoms.

Accordingly, the branched olefins preferably comprise branched alpha olefins having greater than or equal to 4 carbon atoms. Within this range, branched alpha olefins having less than or equal to 20 carbon atoms can be employed, with less than or equal to about 15 carbon atoms preferred. Also preferred within this range is a branched alpha olefin having greater than or equal to about 10 carbon atoms.

In a preferred embodiment, R¹ and R² independently represent a hydrocarbon based radical or group. As used herein, the term “hydrocarbon-based radical or group” denotes a radical or group having a carbon atom directly attached to the remainder of the molecule and having a predominantly hydrocarbon character within the context of this invention. Moreover, in this context the terms “group” and “radical” are used interchangeably. Such radicals include the following:
(1) Hydrocarbon radicals; that is, aliphatic radicals, aromatic- and alicyclic-substituted radicals, and the like.
(2) Substituted hydrocarbon radicals; that is, radicals containing pendant non-hydrocarbon substituents, such as halogen, nitro, hydroxyl, alkoxy, carbalkoxy, and alkythio.
(3) Hetero radicals; that is, radicals which contain atoms other than carbon present as a member of the structure of a chain or ring otherwise composed of carbon atoms. Heteroatoms include, for example, nitrogen, oxygen, phosphorus and sulfur. Such hydrocarbon-based radicals may also be bonded to the carbon-carbon double bond through a heteroatom.

Preferably, the hydrocarbon based radical or group can be substituted or unsubstituted, cyclic or non-cyclic, linear or branched, aliphatic, aromatic, or mixed aliphatic and aromatic including hydrocarbylene, hydrocarbyloxy, hydrocarbylsilyl, hydrocarbylamino, and hydrocarbylsiloxy radicals having up to 50 non-hydrogen atoms. Preferred R¹ and R² groups are independently selected from halo, hydrocarbyl, and substituted hydrocarbyl radicals. The hydrocarbon based radical preferably contain from 1 to about 50 carbon atoms, more preferably from 1 to about 12 carbon atoms, and the substituent group is preferably a halogen atom (F, Cl, Br, I, At).

Preferred R¹ and R² hydrocarbyl radicals are methyl, ethyl, propyl, butyl, amyl, isoamyl, hexyl, isobutyl, heptyl, octyl, nonyl, decyl, cetyl, 2-ethylhexyl, phenyl and the like, with methyl and ethyl being most preferred. Exemplary substituted hydrocarbyl radicals for R¹ and R² include trifluoromethyl, pentafluorphenyl, trimethylsilylmethyl, trimethoxysilylmethyl, and the like.

Preferred branched alpha olefins suitable for use herein include:
alpha-olefins comprising a main chain olefin substituted with side chains. Preferred main chains of the branched alpha olefins include, for example, ethylene, propylene, 1-butene, 3-methyl-1-butene, 1-pentene, 1-hexene, 4-methyl-1-pentene, 1-octene, 1-decene, 1-dodecene, 1-tetradecene, 1-hexadecene, 1-octadecene, 1-eicosene, and the like.

Preferred branched alpha-olefins for use herein more preferably comprise 5 to 10 carbon atoms and have a branch at the 3-position. Examples of preferred branched alpha olefins include 3-methyl-1-pentene, 4-methyl-1-pentene, 3-methyl-1-butene, 3,3-dimethyl-1-butene, 4,4-dimethyl-1-hexene, 3-methyl-1-hexane, 4,4-dimethyl-1-pentene, 3-ethyl-pentene and vinylcyclohexane. 4-Methyl-1-pentene is especially preferred.

In addition to, or in place of branched alpha olefins, the radiation tolerant polymers disclosed herein may also include cyclic olefins, aromatic olefins, various terpolymers, and other branched olefinic and aromatic thermoplastics and elastomers. For example, a radiation tolerant copolymer comprising propylene and one or more cyclic olefins is within the scope of the present invention. Examples of cyclic olefins suitable for use herein include cyclopentene, cyclohexene, norbornene, 1-methylnorbornene, 5-methylnorbornene, 7-methylnorbornene, 5,6-dimethylnorbornene, 5,5,6-trimethylnorbornene, 5-ethylnorbornene, 5-propylnorbornene, 5-phenylnorbornene, and the like.

Preferred aromatic monomers that may be incorporated into the PP/BO copolymer comprising polypropylene, which produce a radiation tolerant copolymer include styrenes and halogenostyrenes. Preferred styrenes suitable for use herein include, for example, styrene and alkylstyrenes such as p-methylstyrene, m-methylstyrene, o-methylstyrene, 2,5-dimethylstyrene, p-t-butylstyrene, and the like. Halogenostyrenes suitable for use herein include p-chlorostyrene, m-chlorostyrene, o-chlorostyrene, p-bromostyrene, m-bromostyrene, o-bromostyrene, p-fluorostyrene, m-fluorostyrene, o-fluorostyrene, o-methyl-p-fluorostyrene, and the like. In addition, vinyl monomers such as vinylbiphenyls may be suitable for use herein to produce a radiation tolerant copolymer comprising propylene. Preferred vinyl monomers include 4-vinylbiphenyl, 3-vinylbiphenyl, 2-vinylbiphenyl, and the like.

Accordingly, the radiation tolerant polymer of the present invention may comprise propylene, and a combination of one or more branched alpha olefins, cyclic olefins, aromatic olefins, vinyl olefins, and/or a combination comprising at least one of the foregoing branched olefins in addition to polypropylene.

Formation of the Copolymer

The copolymer is preferably produced by contacting propylene and one or more branched olefins with a metallocene catalyst, and collecting the copolymer. These materials may be made in a variety of processes including slurry, solution, high pressure, gas phase, or a combination comprising at least one of the following polymerization processes employing metallocene catalysts. Processes for making a variety of polyethylene materials with metallocene catalyst systems are well known, see, for example, U.S. Pat. No. 5,064,802. The propylene/branched alpha olefin comonomer of the present invention is preferably prepared by contacting an amount of propylene and an amount of branched olefin monomer with a metallocene catalyst system, which may include a support, an activator, or the like as described in detail below.

Metallocene Catalyst System

By metallocene catalyst system, it is meant a combination of an activator with a metal compound comprising a transition metal, preferably a group 4 metal, bound to at least one cyclopentadienyl group (cyclopentadienyl group is defined to include substituted cyclopentadienyls, including flourenyls and indenyls (which themselves may be substituted)). By substituted is meant a group in which one or more hydrogen atom to any carbon of the group is replaced by another group such as a halogen, aryl, cycloalkyl, and combinations thereof. For example, “substituted cyclopentadienyl” refers to a cyclopentadienyl group in which one or more hydrogen atom to any carbon of the cyclopentadienyl is replaced by another group such as a halogen, aryl, substituted_aryl, cycloalkyl, substituted cycloalkyl, and combinations thereof. Two or more transition metal compounds can be used in the metallocene catalyst systems described herein. In some embodiments the transitional metal compound comprises two or more cyclopentadienyl groups.

In general, the polymerization is conducted using a metallocene catalyst capable of producing polypropylene, preferably stereoregular polypropylene, activated with an alumoxane, such as methylalumoxane (MAO) or a non-coordinating anion (NCA) activator, and optionally a scavenging compound. Polymerization may be conducted in bulk, in solution, in slurry phase, and/or in gas phase. The polymerization can be performed in a single reactor, in a series reactor or in a parallel reactor process. A slurry, bulk, or solution polymerization process can utilize sub- or superatmospheric pressures and temperatures in the range of from about −25° C. to 150° C.

In a slurry polymerization, a suspension of solid, particulate polymer is formed in a liquid polymerization medium to which the monomers, catalyst and optionally hydrogen are added. In solution polymerization, the liquid medium serves as a solvent for the polymer. The liquid employed as the polymerization medium can be an alkane or a cycloalkane, such as butane, pentane, hexane, or cylclohexane, or an aromatic hydrocarbon, such as toluene, ethylbenzene or xylene. The medium employed should be liquid under the conditions of the polymerization and relatively inert. Preferably, hexane or toluene is employed for solution polymerization. For slurry polymerization, liquid monomer can also be used. Gas phase polymerization processes are described in U.S. Pat. Nos. 4,543,399, 4,588,790, 5,028,670. The catalyst may be supported on any suitable particulate material or porous carrier such as polymeric supports or inorganic oxides—for example silica, alumina or both. Methods of supporting metallocene catalysts are described in U.S. Pat. Nos. 4,808,561, 4,897,455, 4,937,301, 4,937,217, 4,912,075, 5,008,228, 5,086,025, 5,147,949, and 5,238,892.

Among the catalyst compounds, which can be used in this invention, (also called stereospecific catalysts) are described in WO 99/29743, also published as U.S. Pat. No. 6,117,962. Catalysts may also include stereorigid, chiral and/or asymmetric, bridged metallocenes. See, for example, U.S. Pat. No. 4,892,851, U.S. Pat. No. 5,017,714, U.S. Pat. No. 5,132,281, U.S. Pat. No. 5,155,080, U.S. Pat. No. 5,296,434, U.S. Pat. No. 5,278,264, U.S. Pat. No. 5,318,935, U.S. Pat. No. 6,376,409, U.S. Pat. No. 6,380,120, U.S. Pat. No. 6,376,412, WO-A-(PCT/US92/10066), WO-A-93/19103, WO 01/48034, EP-A2-0 577 581, EP-A1-0 578 838, and academic literature “The Influence of Aromatic Substituents on the Polymerization Behavior of Bridged Zirconocene Catalysts”, Spaleck, W., et al, Organometallics 1994, 13, 954-963, and “ansa-Zirconocene Polymerization Catalysts with Annelated Ring Ligands-Effects on Catalytic Activity and Polymer Chain Lengths”, Brintzinger, H., et al, Organometallics 1994, 13, 964-970, and documents referred to therein. In a preferred embodiment, the stereospecific transition metal catalyst compound is a dimethylsiladiyl-bridged bis(indenyl)zirconocene or hafnocene. More preferably, the transition metal catalyst compound is rac-dimethylsiladiyl(2-methyl-4-phenylindenyl)zirconium or hafnium dichloride or dimethyl. In another preferred embodiment, the transition metal catalyst is a dimethylsiladiyl-bridged bis(indenyl)hafnocene such as dimethylsiladiyl bis(indenyl)hafnium dimethyl or dichloride. Illustrative, but not limiting examples of preferred stereospecific metallocene catalysts are the racemic isomers of:
dimethylsiladiyl(2-methyl-4-phenylindenyl)₂metal dichloride;
dimethylsiladiyl(2-methyl-4-phenylindenyl)₂metal dimethyl;
dimethylsiladiyl(2-methyl indenyl)₂metal dichloride;
dimethylsiladiyl(2-methyl indenyl)₂metal dimethyl;
dimethylsiladiyl(indenyl)₂metal dichloride;
dimethylsiladiyl(indenyl)₂metal dimethyl;
dimethylsiladiyl(tetrahydroindenyl)₂metal dichloride;
dimethylsiladiyl(tetrahydroindenyl)₂metal dimethyl;
dimethylsiladiyl(indenyl)₂metal diethyl;
diphenylsiladiyl(indenyl)₂metal dimethyl;
dimethylsiladiyl(2-methyl, 4-[3′,5′-di-tbutylphenyl]indenyl)₂metal dichloride;
dimethylsiladiyl(2-methyl, 4-[3′,5′-di-tbutylphenyl]indenyl)₂metal dimethyl;
dimethylsiladiyl(2-ethyl, 4-[3′,5′-di-tbutylphenyl]indenyl)₂metal dichloride;
dimethylsiladiyl(2-ethyl, 4-[3′,5′-di-tbutylphenyl]indenyl)₂metal dimethyl;
dimethylsiladiyl(2-n-propyl, 4-[3′,5′-di-tbutylphenyl]indenyl)₂metal dichloride;
dimethylsiladiyl(2-n-propyl, 4-[3′,5′-di-tbutylphenyl]indenyl)₂metal dimethyl;
dimethylsiladiyl(2-iso-propyl, 4-[3′,5′-di-tbutylphenyl]indenyl)₂metal dichloride;
dimethylsiladiyl(2-iso-propyl, 4-[3′,5′-di-tbutylphenyl]indenyl)₂metal dimethyl;
dimethylsiladiyl(2-n-butyl, 4-[3′,5′-di-tbutylphenyl]indenyl)₂metal dichloride;
dimethylsiladiyl(2-n-butyl, 4-[3′,5′-di-tbutylphenyl]indenyl)₂metal dimethyl;
dimethylsiladiyl(2-iso-butyl, 4-[3′,5′-di-tbutylphenyl]indenyl)₂metal dichloride;
dimethylsiladiyl(2-iso-butyl, 4-[3′,5′-di-tbutylphenyl]indenyl)₂metal dimethyl;
dimethylsiladiyl(2-sec-butyl, 4-[3′,5′-di-tbutylphenyl]indenyl)₂metal dichloride;
dimethylsiladiyl(2-sec-butyl, 4-[3′,5′-di-tbutylphenyl]indenyl)₂metal dimethyl;
dimethylsiladiyl(2-methyl, 4-[3′,5′-di-phenylphenyl]indenyl)₂metal dichloride;
dimethylsiladiyl(2-methyl, 4-[3′,5′-di-phenylphenyl]indenyl)₂metal dimethyl;
dimethylsiladiyl(2-ethyl, 4-[3′,5′-di-phenylphenyl]indenyl)₂metal dichloride;
dimethylsiladiyl(2-ethyl, 4-[3′,5′-di-phenylphenyl]indenyl)₂metal dimethyl;
dimethylsiladiyl(2-n-propyl, 4-[3′,5′-di-phenylphenyl]indenyl)₂metal dichloride;
dimethylsiladiyl(2-n-propyl, 4-[3′,5′-di-phenylphenyl]indenyl)₂metal dimethyl;
dimethylsiladiyl(2-iso-propyl, 4-[3′,5′-di-phenylphenyl]indenyl)₂metal dichloride;
dimethylsiladiyl(2-iso-propyl, 4-[3′,5′-di-phenylphenyl]indenyl)₂metal dimethyl;
dimethylsiladiyl(2-n-butyl, 4-[3′,5′-di-phenylphenyl]indenyl)₂metal dichloride;
dimethylsiladiyl(2-n-butyl, 4-[3′,5′-di-phenylphenyl]indenyl)₂metal dimethyl;
dimethylsiladiyl(2-iso-butyl, 4-[3′,5′-di-phenylphenyl]indenyl)₂metal dichloride;
dimethylsiladiyl(2-iso-butyl, 4-[3′,5′-di-phenylphenyl]indenyl)₂metal dimethyl;
dimethylsiladiyl(2-sec-butyl, 4-[3′,5′-di-phenylphenyl]indenyl)₂metal dichloride;
dimethylsiladiyl(2-sec-butyl, 4-[3′,5′-di-phenylphenyl]indenyl)₂metal dimethyl;
dimethylsiladiyl(2-tert-butyl, 4-[3′,5′-di-phenylphenyl]indenyl)₂metal dichloride;
dimethylsiladiyl(2-tert-butyl, 4-[3′,5′-di-phenylphenyl]indenyl)₂metal dimethyl;
9-silafluorendiyl(2-methyl, 4-[3′,5′-di-tbutylphenyl]indenyl)₂metal dichloride;
9-silafluorendiyl(2-methyl, 4-[3′,5′-di-tbutylphenyl]indenyl)₂metal dimethyl;
9-silafluorendiyl(2-ethyl, 4-[3′,5′-di-tbutylphenyl]indenyl)₂metal dichloride;
9-silafluorendiyl(2-ethyl, 4-[3′,5′-di-tbutylphenyl]indenyl)₂metal dimethyl;
9-silafluorendiyl(2-n-propyl, 4-[3′,5′-di-tbutylphenyl]indenyl)₂metal dichloride;
9-silafluorendiyl(2-n-propyl, 4-[3′,5′-di-tbutylphenyl]indenyl)₂metal dimethyl;
9-silafluorendiyl(2-iso-propyl, 4-[3′,5′-di-tbutylphenyl]indenyl)₂metal dichloride;
9-silafluorendiyl(2-iso-propyl, 4-[3′,5′-di-tbutylphenyl]indenyl)₂metal dimethyl;
9-silafluorendiyl(2-n-butyl, 4-[3′,5′-di-tbutylphenyl]indenyl)₂metal dichloride;
9-silafluorendiyl(2-n-butyl, 4-[3′,5′-di-tbutylphenyl]indenyl)₂metal dimethyl;
9-silafluorendiyl(2-iso-butyl, 4-[3′,5′-di-tbutylphenyl]indenyl)₂metal dichloride;
9-silafluorendiyl(2-iso-butyl, 4-[3′,5′-di-tbutylphenyl]indenyl)₂metal dimethyl;
9-silafluorendiyl(2-sec-butyl, 4-[3′,5′-di-tbutylphenyl]indenyl)₂metal dichloride;
9-silafluorendiyl(2-sec-butyl, 4-[3′,5′-di-tbutylphenyl]indenyl)₂metal dimethyl;
9-silafluorendiyl(2-tert-butyl, 4-[3′,5′-di-tbutylphenyl]indenyl)₂metal dichloride;
9-silafluorendiyl(2-tert-butyl, 4-[3′,5′-di-tbutylphenyl]indenyl)₂metal dimethyl;
   wherein the metal can be chosen from Zr, Hf; or Ti, preferably Zr.

Illustrative, but not limiting examples of preferred non-stereospecific metallocene catalysts are:
[dimethylsilanediyl(tetramethylcyclopentadienyl)(cyclododecylamido)]metal dihalide;
[dimethylsilanediyl(tetramethylcyclopentadienyl)(t-butylamido)]metal dihalide; and
[dimethylsilanediyl(tetramethylcyclopentadienyl)(exo-2-norbornyl)]metal dichalide;
   wherein the metal can chosen from Zr, Hf, or Ti, preferably Ti and the halide is preferably chlorine.

Particularly preferred compounds include:
dimethylsiladiyl(tetramethylcyclopentadienyl)(cyclododecylamido)titanium dichloride,
dimethylsiladiyl(tetramethylcyclopentadienyl)(cyclohexyl-amido)titanium dichloride,
dimethylsiladiyl(tetramethylcyclopentadienyl)(1-adamantylamido)titanium dichloride,
dimethylsiladiyl(tetramethylcyclopentadienyl)(t-butylamido)titanium dichloride,
dimethylsiladiyl(tetramethylcyclopentadienyl)(s-butylamido)titanium dichloride,
dimethylsiladiyl(tetramethylcyclopentadienyl)(n-butylamido)titanium dichloride,
dimethylsiladiyl(tetramethylcyclopentadienyl)(exo-2-norbomylamido)titanium dichloride,
diethylsilyl(tetramethylcyclopentadienyl)(cyclododecyl-amido)titanium dichloride,
diethylsilyl(tetramethylcyclopentadienyl)(exo-2-norbornylamido)titanium dichloride,
diethylsilyl(tetramethylcyclopentadienyl)(cyclohexyl-amido)titanium dichloride,
diethylsilyl(tetramethylcyclopentadienyl)(1-adamantylamido)titanium dichloride,
methylene(tetramethylcyclopentadienyl)(cyclododecyl-amido)titanium dichloride,
methylene(tetramethylcyclopentadienyl)(exo-2-norbornylamido)titanium
dichloride, methylene(tetramethylcyclopentadienyl)(cyclohexyl-amido)titanium dichloride,
methylene(tetramethylcyclopentadienyl)(1-adamantylamido)titanium dichloride,
dimethylsiladiyl(tetramethylcyclopentadienyl)(cyclododecylamido)titanium dimethyl,
dimethylsiladiyl(tetramethylcyclopentadienyl)(exo-2-norbornylamido)titanium dimethyl,
dimethylsiladiyl(tetramethylcyclopentadienyl)(cyclohexyl-amido)titanium dimethyl,
dimethylsiladiyl(tetramethylcyclopentadienyl)(1-adamantylamido)titanium dimethyl,
dimethylsiladiyl(2,5-dimethylcyclopentadienyl)(cyclododecylamido)titanium dichloride,
dimethylsiladiyl(2,5-dimethylcyclopentadienyl)(exo-2-norbornylamido)titanium dichloride,
dimethylsiladiyl(2,5-dimethylcyclopentadienyl)(cyclohexylamido)titanium dichloride,
dimethylsiladiyl(2,5-dimethylcyclopentadienyl)(1-adamantylamido)titanium dichloride,
dimethylsiladiyl(3,4-dimethylcyclopentadienyl)(cyclododecylamido)titanium dichloride,
dimethylsiladiyl(3,4-dimethylcyclopentadienyl)(exo-2-norbornylamido)titanium dichloride,
dimethylsiladiyl(3,4-dimethylcyclopentadienyl)(cyclohexylamido)titanium dichloride,
dimethylsiladiyl(3,4-dimethylcyclopentadienyl)(1-adamantylamido)titanium dichloride,
dimethylsiladiyl(2-ethyl-5-methylcyclopentadienyl)(cyclododecylamido)titanium dichloride,
dimethylsiladiyl(2-ethyl-5-methylcyclopentadienyl)(exo-2-norbornylamido)titanium dichloride, dimethylsiladiyl(2-ethyl-5-methylcyclopentadienyl)(cyclohexylamido)titanium dichloride,
dimethylsiladiyl(2-ethyl-5-methylcyclopentadienyl)(1-adamantylamido)titanium dichloride,
dimethylsiladiyl(3-ethyl-4-methylcyclopentadienyl)(cyclododecylamido)titanium dichloride,
dimethylsiladiyl(3-ethyl-4-methylcyclopentadienyl)(exo-2-norbornylamido)titanium dichloride,
dimethylsiladiyl(3-ethyl-4-methylcyclopentadienyl)(cyclohexylamido)titanium dichloride,
dimethylsiladiyl(3-ethyl-4-methylcyclopentadienyl)(1-adamantylamido)titanium dichloride,
dimethylsiladiyl(2-ethyl-3-hexyl-5-methyl-4-octylcyclopentadienyl)(cyclododecylamido)titanium dichloride,
dimethylsiladiyl(2-ethyl-3-hexyl-5-methyl-4-octylcyclopentadienyl)(exo-2-norbornylamido)titanium dichloride,
dimethylsiladiyl(2-ethyl-3-hexyl-5-methyl-4-octylcyclopentadienyl)(cyclohexylamido)titanium dichloride,
dimethylsiladiyl(2-ethyl-3-hexyl-5-methyl-4-octylcyclopentadienyl)(1-adamantylamido)titanium dichloride,
dimethylsiladiyl(2-tetrahydroindenyl)(cyclododecylamido)titanium dichloride,
dimethylsiladiyl(2-tetrahydroindenyl)(cyclohexylamido)titanium dichloride,
dimethylsiladiyl(2-tetrahydroindenyl)(1-adamantylamido)titanium dichloride, and
dimethylsiladiyl(2-tetrahydroindenyl)(exo-2-norbornylamido)titanium dichloride.

In addition preferred species include the dialkyl versions (such as dimethylated versions) of the above compounds, i.e. titanium dimethyl instead of titanium dichloride.

Additional preferred compounds include:
dimethylsiladiyl(2-methyl, 4-[3′,5′-di-tbutylphenyl]indenyl)₂zirconium dichloride;
dimethylsiladiyl(2-ethyl, 4-[3′,5′-di-tbutylphenyl]indenyl)₂zirconium dichloride;
dimethylsiladiyl(2-n-propyl, 4-[3′,5′-di-tbutylphenyl]indenyl)₂zirconium dichloride;
dimethylsiladiyl(2-iso-propyl, 4-[3′,5′-di-tbutylphenyl]indenyl)₂zirconium dichloride;
dimethylsiladiyl(2-n-butyl, 4-[3′,5′-di-tbutylphenyl]indenyl)₂zirconium dichloride;
dimethylsiladiyl(2-iso-butyl, 4-[3′,5′-di-tbutylphenyl]indenyl)₂zirconium dichloride;
dimethylsiladiyl(2-sec-butyl, 4-[3′,5′-di-tbutylphenyl]indenyl)₂zirconium dichloride;
dimethylsiladiyl(2-tert-butyl, 4-[3′,5′-di-tbutylphenyl]indenyl)₂zirconium dichloride;
dimethylsiladiyl(2-methyl, 4-[3′,5′-di-tbutylphenyl]indenyl)₂hafnium dichloride;
dimethylsiladiyl(2-ethyl, 4-[3′,5′-di-tbutylphenyl]indenyl)₂hafnium dichloride;
dimethylsiladiyl(2-n-propyl, 4-[3′,5′-di-tbutylphenyl]indenyl)₂hafnium
dimethylsiladiyl(2-iso-propyl, 4-[3′,5′-di-tbutylphenyl]indenyl)₂hafnium dichloride;
dimethylsiladiyl(2-butyl, 4-[3′,5′-di-tbutylphenyl]indenyl)₂hafnium dichloride;
9-silafluorendiyl(2-methyl, 4-[3′,5′-di-tbutylphenyl]indenyl)₂zirconium dichloride;
9-silafluorendiyl(2-ethyl, 4-[3′,5′-di-tbutylphenyl]indenyl)₂zirconium dichloride;
9-silafluorendiyl(2-n-propyl, 4-[3′,5′-di-tbutylphenyl]indenyl)₂zirconium dichloride;
9-silafluorendiyl(2-iso-propyl, 4-[3′,5′-di-tbutylphenyl]indenyl)₂zirconium dichloride;
9-silafluorendiyl(2-n-butyl, 4-[3′,5′-di-tbutylphenyl]indenyl)₂zirconium dichloride;
9-silafluorendiyl(2-iso-butyl, 4-[3′,5′-di-tbutylphenyl]indenyl)₂zirconium dichloride;
9-silafluorendiyl(2-sec-butyl, 4-[3′,5′-di-tbutylphenyl]indenyl)₂zirconium dichloride;
9-silafluorendiyl(2-tert-butyl, 4-[3′,5′-di-tbutylphenyl]indenyl)₂zirconium dichloride;
9-silafluorendiyl(2-methyl, 4-[3′,5′-di-tbutylphenyl]indenyl)₂hafnium dichloride;
9-silafluorendiyl(2-ethyl, 4-[3′,5′-di-tbutylphenyl]indenyl)₂hafnium dichloride;
9-silafluorendiyl(2-n-propyl, 4-[3′,5′-di-tbutylphenyl]indenyl)₂hafnium dichloride;
9-silafluorendiyl(2-iso-propyl, 4-[3′,5′-di-tbutylphenyl]indenyl)₂hafnium dichloride;
9-silafluorendiyl(2-n-butyl, 4-[3′,5′-di-tbutylphenyl]indenyl)₂hafnium dichloride;
9-silafluorendiyl(2-iso-butyl, 4-[3′,5′-di-tbutylphenyl]indenyl)₂hafnium dichloride;
9-silafluorendiyl(2-sec-butyl, 4-[3′,5′-di-tbutylphenyl]indenyl)₂hafnium dichloride;
9-silafluorendiyl(2-tert-butyl, 4-[3′,5′-di-tbutylphenyl]indenyl)₂hafnium dichloride;
dimethylsiladiyl(2-methyl, 4-[3′,5′-di-tbutylphenyl]indenyl)₂zirconium dimethyl;
dimethylsiladiyl(2-ethyl, 4-[3′,5′-di-tbutylphenyl]indenyl)₂zirconium dimethyl;
dimethylsiladiyl(2-n-propyl, 4-[3′,5′-di-tbutylphenyl]indenyl)₂zirconium dimethyl;
dimethylsiladiyl(2-iso-propyl, 4-[3′,5′-di-tbutylphenyl]indenyl)₂zirconium dimethyl;
dimethylsiladiyl(2-n-butyl, 4-[3′,5′-di-tbutylphenyl]indenyl)₂zirconium dimethyl;
dimethylsiladiyl(2-iso-butyl, 4-[3′,5′-di-tbutylphenyl]indenyl)₂zirconium dimethyl;
dimethylsiladiyl(2-sec-butyl, 4-[3′,5′-di-tbutylphenyl]indenyl)₂zirconium dimethyl;
dimethylsiladiyl(2-tert-butyl, 4-[3′,5′-di-tbutylphenyl]indenyl)₂zirconium dimethyl;
dimethylsiladiyl(2-methyl, 4-[3′,5′-di-tbutylphenyl]indenyl)₂hafnium dimethyl;
dimethylsiladiyl(2-ethyl, 4-[3′,5′-di-tbutylphenyl]indenyl)₂hafnium dimethyl;
dimethylsiladiyl(2-n-propyl, 4-[3′,5′-di-tbutylphenyl]indenyl)₂hafnium dimethyl
dimethylsiladiyl(2-iso-propyl, 4-[3′,5′-di-tbutylphenyl]indenyl)₂hafnium dimethyl;
dimethylsiladiyl(2-n-butyl, 4-[3′,5′-di-tbutylphenyl]indenyl)₂hafnium dimethyl;
dimethylsiladiyl(2-iso-butyl, 4-[3′,5′-di-tbutylphenyl]indenyl)₂hafnium dimethyl;
dimethylsiladiyl(2-sec-butyl, 4-[3′,5′-di-tbutylphenyl]indenyl)₂hafnium dimethyl;
dimethylsiladiyl(2-tert-butyl, 4-[3′,5′-di-tbutylphenyl]indenyl)₂hafnium dimethyl;
9-silafluorendiyl(2-methyl, 4-[3′,5′-di-tbutylphenyl]indenyl)₂zirconium dimethyl;
9-silafluorendiyl(2-ethyl, 4-[3′,5′-di-tbutylphenyl]indenyl)₂zirconium dimethyl;
9-silafluorendiyl(2-n-propyl, 4-[3′,5′-di-tbutylphenyl]indenyl)₂zirconium dimethyl;
9-silafluorendiyl(2-iso-propyl, 4-[3′,5′-di-tbutylphenyl]indenyl)₂zirconium dimethyl;
9-silafluorendiyl(2-n-butyl, 4-[3′,5′-di-tbutylphenyl]indenyl)₂zirconium dimethyl;
9-silafluorendiyl(2-iso-butyl, 4-[3′,5′-di-tbutylphenyl]indenyl)₂zirconium dimethyl;
9-silafluorendiyl(2-sec-butyl, 4-[3′,5′-di-tbutylphenyl]indenyl)₂zirconium dimethyl;
9-silafluorendiyl(2-tert-butyl, 4-[3′,5′-di-tbutylphenyl]indenyl)₂zirconium dimethyl;
9-silafluorendiyl(2-methyl, 4-[3′,5′-di-tbutylphenyl]indenyl)₂hafnium dimethyl;
9-silafluorendiyl(2-ethyl, 4-[3′,5′-di-tbutylphenyl]indenyl)₂hafnium dimethyl;
9-silafluorendiyl(2-n-propyl, 4-[3′,5′-di-tbutylphenyl]indenyl)₂hafnium dimethyl;
9-silafluorendiyl(2-iso-propyl, 4-[3′,5′-di-tbutylphenyl]indenyl)₂hafnium dimethyl;
9-silafluorendiyl(2-n-butyl, 4-[3′,5′-di-tbutylphenyl]indenyl)₂hafnium dimethyl;
9-silafluorendiyl(2-iso-butyl, 4-[3′,5′-di-tbutylphenyl]indenyl)₂hafnium dimethyl;
9-silafluorendiyl(2-sec-butyl, 4-[3′,5′-di-tbutylphenyl]indenyl)₂hafnium dimethyl;
9-silafluorendiyl(2-tert-butyl, 4-[3′,5′-di-tbutylphenyl]indenyl)₂hafnium dimethyl;
dimethylsiladiyl(2-methyl, 4-[3′,5′-bis-trifluoromethylphenyl]indenyl)₂zirconium dichloride;
dimethylsiladiyl(2-ethyl, 4-[3′,5′-bis-trifluoromethylphenyl]indenyl)₂zirconium dichloride;
dimethylsiladiyl(2-n-propyl, 4-[3′,5′-bis-trifluoromethylphenyl]indenyl)₂zirconium dichloride;
dimethylsiladiyl(2-iso-propyl, 4-[3′,5′-bis-trifluoromethylphenyl]indenyl)₂zirconium dichloride;
dimethylsiladiyl(2-n-butyl, 4-[3′,5′-bis-trifluoromethylphenyl]indenyl)₂zirconium dichloride;
dimethylsiladiyl(2-iso-butyl, 4-[3′,5′-bis-trifluoromethylphenyl]indenyl)₂zirconium dichloride;
dimethylsiladiyl(2-sec-butyl, 4-[3′,5′-bis-trifluoromethylphenyl]indenyl)₂zirconium dichloride;
dimethylsiladiyl(2-tert-butyl, 4-[3′,5′-bis-trifluoromethylphenyl]indenyl)₂zirconium dichloride;
dimethylsiladiyl(2-methyl, 4-[3′,5′-bis-trifluoromethylphenyl]indenyl)₂hafnium dichloride;
dimethylsiladiyl(2-ethyl, 4-[3′,5′-bis-trifluoromethylphenyl]indenyl)₂hafnium dichloride;
dimethylsiladiyl(2-n-propyl, 4-[3′,5′-bis-trifluoromethylphenyl]indenyl)₂hafnium dichloride;
dimethylsiladiyl(2-iso-propyl, 4-[3′,5′-bis-trifluoromethylphenyl]indenyl)₂hafnium dichloride;
dimethylsiladiyl(2-n-butyl, 4-[3′,5′-bis-trifluoromethylphenyl]indenyl)₂hafnium dichloride;
dimethylsiladiyl(2-iso-butyl, 4-[3′,5′-bis-trifluoromethylphenyl]indenyl)₂hafnium dichloride;
dimethylsiladiyl(2-sec-butyl, 4-[3′,5′-bis-trifluoromethylphenyl]indenyl)₂hafnium dichloride;
dimethylsiladiyl(2-tert-butyl, 4-[3′,5′-bis-trifluoromethylphenyl]indenyl)₂hafnium dichloride;
9-silafluorendiyl(2-methyl, 4-[3′,5′-bis-trifluoromethylphenyl]indenyl)₂zirconium dichloride;
dimethylsiladiyl(2-ethyl, 4-[3′,5′-bis-trifluoromethylphenyl]indenyl)₂hafnium dichloride;
9-silafluorendiyl(2-n-propyl, 4-[3′,5′-bis-trifluoromethylphenyl]indenyl)₂zirconium dichloride;
9-silafluorendiyl(2-iso-propyl, 4-[3′,5′-bis-trifluoromethylphenyl]indenyl)₂zirconium dichloride;
9-silafluorendiyl(2-n-butyl, 4-[3′,5′-bis-trifluoromethylphenyl]indenyl)₂zirconium dichloride;
9-silafluorendiyl(2-iso-butyl, 4-[3′,5′-bis-trifluoromethylphenyl]indenyl)₂zirconium dichloride;
9-silafluorendiyl(2-sec-butyl, 4-[3′,5′-bis-trifluoromethylphenyl]indenyl)₂zirconium dichloride;
9-silafluorendiyl(2-tert-butyl, 4-[3′,5′-bis-trifluoromethylphenyl]indenyl)₂zirconium dichloride;
9-silafluorendiyl(2-methyl, 4-[3′,5′-bis-trifluoromethylphenyl]indenyl)₂hafnium dichloride;
9-silafluorendiyl(2-ethyl, 4-[3′,5′-bis-trifluoromethylphenyl]indenyl)₂hafnium dichloride;
9-silafluorendiyl(2-n-propyl, 4-[3′,5′-bis-trifluoromethylphenyl]indenyl)₂ hafnium dichloride;
9-silafluorendiyl(2-iso-propyl, 4-[3′,5′-bis-trifluoromethylphenyl]indenyl)₂ hafnium dichloride;
9-silafluorendiyl(2-n-butyl, 4-[3′,5′-bis-trifluoromethylphenyl]indenyl)₂hafnium dichloride;
9-silafluorendiyl(2-iso-butyl, 4-[3′,5′-bis-trifluoromethylphenyl]indenyl)₂hafnium dichloride;
9-silafluorendiyl(2-sec-butyl, 4-[3′,5′-bis-trifluoromethylphenyl]indenyl)₂hafnium dichloride;
9-silafluorendiyl(2-tert-butyl, 4-[3′,5′-bis-trifluoromethylphenyl]indenyl)₂hafnium dichloride;
dimethylsiladiyl(2-methyl, 4-[3′,5′-bis-trifluoromethylphenyl]indenyl)₂zirconium dimethyl;
dimethylsiladiyl(2-ethyl, 4-[3′,5′-bis-trifluoromethylphenyl]indenyl)₂zirconium dimethyl;
dimethylsiladiyl(2-n-propyl, 4-[3′,5′-bis-trifluoromethylphenyl]indenyl)₂zirconium dimethyl;
dimethylsiladiyl(2-iso-propyl, 4-[3′,5′-bis-trifluoromethylphenyl]indenyl)₂zirconium dimethyl;
dimethylsiladiyl(2-n-butyl, 4-[3′,5′-bis-trifluoromethylphenyl]indenyl)₂zirconium dimethyl;
dimethylsiladiyl(2-iso-butyl, 4-[3′,5′-bis-trifluoromethylphenyl]indenyl)₂zirconium dimethyl;
dimethylsiladiyl(2-sec-butyl, 4-[3′,5′-bis-trifluoromethylphenyl]indenyl)₂zirconium dimethyl;
dimethylsiladiyl(2-tert-butyl, 4-[3′,5′-bis-trifluoromethylphenyl]indenyl)₂zirconium dimethyl;
dimethylsiladiyl(2-methyl, 4-[3′,5′-bis-trifluoromethylphenyl]indenyl)₂hafnium dimethyl;
dimethylsiladiyl(2-ethyl, 4-[3′,5′-bis-trifluoromethylphenyl]indenyl)₂hafnium dimethyl;
dimethylsiladiyl(2-n-propyl, 4-[3′,5′-bis-trifluoromethylphenyl]indenyl)₂hafnium dimethyl;
dimethylsiladiyl(2-iso-propyl, 4-[3′,5′-bis-trifluoromethylphenyl]indenyl)₂hafnium dimethyl;
dimethylsiladiyl(2-n-butyl, 4-[3′,5′-bis-trifluoromethylphenyl]indenyl)₂hafnium dimethyl;
dimethylsiladiyl(2-iso-butyl, 4-[3′,5′-bis-trifluoromethylphenyl]indenyl)₂hafnium dimethyl;
dimethylsiladiyl(2-sec-butyl, 4-[3′,5′-bis-trifluoromethylphenyl]indenyl)₂hafnium dimethyl;
dimethylsiladiyl(2-tert-butyl, 4-[3′,5′-bis-trifluoromethylphenyl]indenyl)₂hafnium dimethyl;
9-silafluorendiyl(2-methyl, 4-[3′,5′-bis-trifluoromethylphenyl]indenyl)₂zirconium dimethyl;
dimethylsiladiyl(2-ethyl, 4-[3′,5′-bis-trifluoromethylphenyl]indenyl)₂hafnium dimethyl;
9-silafluorendiyl(2-n-propyl, 4-[3′,5′-bis-trifluoromethylphenyl]indenyl)₂zirconium dimethyl;
9-silafluorendiyl(2-iso-propyl, 4-[3′,5′-bis-trifluoromethylphenyl]indenyl)₂zirconium dimethyl;
9-silafluorendiyl(2-n-butyl, 4-[3′,5′-bis-trifluoromethylphenyl]indenyl)₂zirconium dimethyl;
9-silafluorendiyl(2-iso-butyl, 4-[3′,5′-bis-trifluoromethylphenyl]indenyl)₂zirconium dimethyl;
9-silafluorendiyl(2-sec-butyl, 4-[3′,5′-bis-trifluoromethylphenyl]indenyl)₂zirconium dimethyl;
9-silafluorendiyl(2-tert-butyl, 4-[3′,5′-bis-trifluoromethylphenyl]indenyl)₂zirconium dimethyl;
9-silafluorendiyl(2-methyl, 4-[3′,5′-bis-trifluoromethylphenyl]indenyl)₂hafnium dimethyl;
9-silafluorendiyl(2-ethyl, 4-[3′,5′-bis-trifluoromethylphenyl]indenyl)₂hafnium dimethyl;
9-silafluorendiyl(2-n-propyl, 4-[3′,5′-bis-trifluoromethylphenyl]indenyl)₂hafnium dimethyl;
9-silafluorendiyl(2-iso-propyl, 4-[3′,5′-bis-trifluoromethylphenyl]indenyl)₂hafnium dimethyl;
9-silafluorendiyl(2-n-butyl, 4-[3′,5′-bis-trifluoromethylphenyl]indenyl)₂hafnium dimethyl;
9-silafluorendiyl(2-iso-butyl, 4-[3′,5′-bis-trifluoromethylphenyl]indenyl)₂hafnium dimethyl;
9-silafluorendiyl(2-sec-butyl, 4-[3′,5′-bis-trifluoromethylphenyl]indenyl)₂hafnium dimethyl;
9-silafluorendiyl(2-tert-butyl, 4-[3′,5′-bis-trifluoromethylphenyl]indenyl)₂hafnium dimethyl;
dimethylsiladiyl(2-ethyl, 4-[3′,5′-di-iso-propylphenyl]indenyl)₂zirconium dichloride;
dimethylsiladiyl(2-n-propyl, 4-[3′,5′-di-iso-propylphenyl]indenyl)₂zirconium dichloride
dimethylsiladiyl(2-iso-propyl, 4-[3′,5′-di-iso-propylphenyl]indenyl)₂zirconium dichloride;
dimethylsiladiyl(2-n-butyl, 4-[3′,5′-di-iso-propylphenyl]indenyl)₂zirconium dichloride;
dimethylsiladiyl(2-iso-butyl, 4-[3′,5′-di-iso-propylphenyl]indenyl)₂zirconium dichloride;
dimethylsiladiyl(2-sec-butyl, 4-[3′,5′-di-iso-propylphenyl]indenyl)₂zirconium dichloride;
dimethylsiladiyl(2-tert-butyl, 4-[3′,5′-di-iso-propylphenyl]indenyl)₂zirconium dichloride;
dimethylsiladiyl(2-ethyl, 4-[3′,5′-di-iso-propylphenyl]indenyl)₂hafnium dichloride;
dimethylsiladiyl(2-n-propyl, 4-[3′,5′-di-iso-propylphenyl]indenyl)₂hafnium dichloride;
dimethylsiladiyl(2-iso-propyl, 4-[3′,5′-di-iso-propylphenyl]indenyl)₂hafnium dichloride;
dimethylsiladiyl(2-n-butyl, 4-[3′,5′-di-iso-propylphenyl]indenyl)₂hafnium dichloride;
dimethylsiladiyl(2-iso-butyl, 4-[3′,5′-di-iso-propylphenyl]indenyl)₂hafnium dichloride;
dimethylsiladiyl(2-sec-butyl, 4-[3′,5′-di-iso-propylphenyl]indenyl)₂hafnium dichloride;
dimethylsiladiyl(2-tert-butyl, 4-[3′,5′-di-iso-propylphenyl]indenyl)₂hafnium dichloride;
9-silafluorendiyl(2-ethyl, 4-[3′,5′-di-iso-propylphenyl]indenyl)₂zirconium dichloride;
9-silafluorendiyl(2-n-propyl, 4-[3′,5′-di-iso-propylphenyl]indenyl)₂zirconium dichloride;
9-silafluorendiyl(2-iso-propyl, 4-[3′,5′-di-iso-propylphenyl]indenyl)₂zirconium dichloride;
9-silafluorendiyl(2-n-butyl, 4-[3′,5′-di-iso-propylphenyl]indenyl)₂zirconium dichloride;
9-silafluorendiyl(2-iso-butyl, 4-[3′,5′-di-iso-propylphenyl]indenyl)₂zirconium dichloride;
9-silafluorendiyl(2-sec-butyl, 4-[3′,5′-di-iso-propylphenyl]indenyl)₂zirconium dichloride;
9-silafluorendiyl(2-tert-butyl, 4-[3′,5′-di-iso-propylphenyl]indenyl)₂zirconium dichloride;
9-silafluorendiyl(2-ethyl, 4-[3′,5′-di-iso-propylphenyl]indenyl)₂hafnium dichloride;
9-silafluorendiyl(2-n-propyl, 4-[3′,5′-di-iso-propylphenyl]indenyl)₂hafnium dichloride;
9-silafluorendiyl(2-iso-propyl, 4-[3′,5′-di-iso-propylphenyl]indenyl)₂hafnium dichloride;
9-silafluorendiyl(2-n-butyl, 4-[3′,5′-di-iso-propylphenyl]indenyl)₂hafnium dichloride;
9-silafluorendiyl(2-iso-butyl, 4-[3′,5′-di-iso-propylphenyl]indenyl)₂hafnium dichloride;
9-silafluorendiyl(2-sec-butyl, 4-[3′,5′-di-iso-propylphenyl]indenyl)₂hafnium dichloride;
9-silafluorendiyl(2-tert-butyl, 4-[3′,5′-di-iso-propylphenyl]indenyl)₂hafnium dichloride;
dimethylsiladiyl(2-ethyl, 4-[3′,5′-di-iso-propylphenyl]indenyl)₂zirconium dimethyl;
dimethylsiladiyl(2-n-propyl, 4-[3′,5′-di-iso-propylphenyl]indenyl)₂zirconium dimethyl
dimethylsiladiyl(2-iso-propyl, 4-[3′,5′-di-iso-propylphenyl]indenyl)₂zirconium dimethyl;
dimethylsiladiyl(2-n-butyl, 4-[3′,5′-di-iso-propylphenyl]indenyl)₂zirconium dimethyl;
dimethylsiladiyl(2-isobutyl, 4-[3′,5′-di-iso-propylphenyl]indenyl)₂zirconium dimethyl;
dimethylsiladiyl(2-sec-butyl, 4-[3′,5′-di-iso-propylphenyl]indenyl)₂zirconium dimethyl;
dimethylsiladiyl(2-tert-butyl, 4-[3′,5′-di-iso-propylphenyl]indenyl)₂zirconium dimethyl;
dimethylsiladiyl(2-ethyl, 4-[3′,5′-di-iso-propylphenyl]indenyl)₂hafnium dimethyl;
dimethylsiladiyl(2-n-propyl, 4-[3 ′,5′-di-iso-propylphenyl]indenyl)₂hafnium dimethyl;
dimethylsiladiyl(2-iso-propyl, 4-[3′,5′-di-iso-propylphenyl]indenyl)₂hafnium dimethyl;
dimethylsiladiyl(2-n-butyl, 4-[3′,5′-di-iso-propylphenyl]indenyl)₂hafnium dimethyl;
dimethylsiladiyl(2-iso-butyl, 4-[3′,5′-di-iso-propylphenyl]indenyl)₂zirconium dimethyl;
dimethylsiladiyl(2-sec-butyl, 4-[3′,5′-di-iso-propylphenyl]indenyl)₂zirconium dimethyl;
dimethylsiladiyl(2-tert-butyl, 4-[3′,5′-di-iso-propylphenyl]indenyl)₂zirconium dimethyl;
9-silafluorendiyl(2-ethyl, 4-[3′,5′-di-iso-propylphenyl]indenyl)₂zirconium dimethyl;
9-silafluorendiyl(2-n-propyl, 4-[3′,5′-di-iso-propylphenyl]indenyl)₂zirconium dimethyl;
9-silafluorendiyl(2-iso-propyl, 4-[3′,5′-di-iso-propylphenyl]indenyl)₂zirconium dimethyl;
9-silafluorendiyl(2-n-butyl, 4-[3′,5′-di-iso-propylphenyl]indenyl)₂zirconium dimethyl;
9-silafluorendiyl(2-iso-butyl, 4-[3′,5′-di-iso-propylphenyl]indenyl)₂zirconium dimethyl;
9-silafluorendiyl(2-sec-butyl, 4-[3′,5′-di-iso-propylphenyl]indenyl)₂zirconium dimethyl;
9-silafluorendiyl(2-tert-butyl, 4-[3′,5′-di-iso-propylphenyl]indenyl)₂zirconium dimethyl;
9-silafluorendiyl(2-ethyl, 4-[3′,5′-di-iso-propylphenyl]indenyl)₂hafnium dimethyl;
9-silafluorendiyl(2-n-propyl, 4-[3′,5′-di-iso-propylphenyl]indenyl)₂hafnium dimethyl;
9-silafluorendiyl(2-iso-propyl, 4-[3′,5′-di-iso-propylphenyl]indenyl)₂hafnium dimethyl;
9-silafluorendiyl(2-n-butyl, 4-[3′,5′-di-iso-propylphenyl]indenyl)₂hafnium dimethyl;
9-silafluorendiyl(2-iso-butyl, 4-[3′,5′-di-iso-propylphenyl]indenyl)₂hafnium dimethyl;
9-silafluorendiyl(2-sec-butyl, 4-[3′,5′-di-iso-propylphenyl]indenyl)₂hafnium dimethyl;
9-silafluorendiyl(2-tert-butyl, 4-[3′,5′-di-iso-propylphenyl]indenyl)₂hafnium dimethyl;
dimethylsiladiyl(2-methyl, 4-[3′,5′-di-phenylphenyl]indenyl)₂zirconium dichloride;
dimethylsiladiyl(2-ethyl, 4-[3′,5′-di-phenylphenyl]indenyl)₂zirconium dichloride;
dimethylsiladiyl(2-n-propyl, 4-[3′,5′-di-phenylphenyl]indenyl)₂zirconium dichloride;
dimethylsiladiyl(2-iso-propyl, 4-[3′,5′-di-phenylphenyl]indenyl)₂zirconium dichloride;
dimethylsiladiyl(2-n-butyl, 4-[3′,5′-di-phenylphenyl]indenyl)₂zirconium dichloride;
dimethylsiladiyl(2-iso-butyl, 4-[3′,5′-di-phenylphenyl]indenyl)₂zirconium dichloride;
dimethylsiladiyl(2-sec-butyl, 4-[3′,5′-di-phenylphenyl]indenyl)₂zirconium dichloride;
dimethylsiladiyl(2-tert-butyl, 4-[3′,5′-di-phenylphenyl]indenyl)₂zirconium dichloride;
dimethylsiladiyl(2-methyl, 4-[3′,5′-di-phenylphenyl]indenyl)₂hafnium dichloride;
dimethylsiladiyl(2-ethyl, 4-[3′,5′-di-phenylphenyl]indenyl)₂hafnium dichloride;
dimethylsiladiyl(2-n-propyl, 4-[3′,5′-di-phenylphenyl]indenyl)₂hafnium dichloride;
dimethylsiladiyl(2-iso-propyl, 4-[3′,5′-di-phenylphenyl]indenyl)₂hafnium dichloride;
dimethylsiladiyl(2-n-butyl, 4-[3′,5′-di-phenylphenyl]indenyl)₂hafnium dichloride;
dimethylsiladiyl(2-iso-butyl, 4-[3′,5′-di-phenylphenyl]indenyl)₂hafnium dichloride;
dimethylsiladiyl(2-sec-butyl, 4-[3′,5′-di-phenylphenyl]indenyl)₂hafnium dichloride;
dimethylsiladiyl(2-tert-butyl, 4-[3′,5′-di-phenylphenyl]indenyl)₂hafnium dichloride;
9-silafluorendiyl(2-methyl, 4-[3′,5′-di-phenylphenyl]indenyl)₂zirconium dichloride;
9-silafluorendiyl(2-ethyl, 4-[3′,5′-di-phenylphenyl]indenyl)₂zirconium dichloride;
9-silafluorendiyl(2-n-propyl, 4-[3′,5′-di-phenylphenyl]indenyl)₂zirconium dichloride;
9-silafluorendiyl(2-iso-propyl, 4-[3′,5′-di-phenylphenyl]indenyl)₂zirconium dichloride;
9-silafluorendiyl(2-n-butyl, 4-[3′,5′-di-phenylphenyl]indenyl)₂zirconium dichloride;
9-silafluorendiyl(2-iso-butyl, 4-[3′,5′-di-phenylphenyl]indenyl)₂zirconium dichloride;
9-silafluorendiyl(2-sec-butyl, 4-[3′,5′-di-phenylphenyl]indenyl)₂zirconium dichloride;
9-silafluorendiyl(2-tert-butyl, 4-[3′,5′-di-phenylphenyl]indenyl)₂zirconium dichloride;
9-silafluorendiyl(2-methyl, 4-[3′,5′-di-phenylphenyl]indenyl)₂hafnium dichloride;
9-silafluorendiyl(2-ethyl, 4-[3′,5′-di-phenylphenyl]indenyl)₂hafnium dichloride;
9-silafluorendiyl(2-n-propyl, 4-[3′,5′-di-phenylphenyl]indenyl)₂hafnium dichloride;
9-silafluorendiyl(2-iso-propyl, 4-[3′,5′-di-phenylphenyl]indenyl)₂hafnium dichloride;
9-silafluorendiyl(2-n-butyl, 4-[3′,5′-di-phenylphenyl]indenyl)₂hafnium dichloride;
9-silafluorendiyl(2-iso-butyl, 4-[3′,5′-di-phenylphenyl]indenyl)₂hafnium dichloride;
9-silafluorendiyl(2-sec-butyl, 4-[3′,5′-di-phenylphenyl]indenyl)₂hafnium dichloride;
9-silafluorendiyl(2-tert-butyl, 4-[3′,5′-di-phenylphenyl]indenyl)₂hafnium dichloride;
dimethylsiladiyl(2-methyl, 4-[3′,5′-di-phenylphenyl]indenyl)₂zirconium dimethyl;
dimethylsiladiyl(2-ethyl, 4-[3′,5′-di-phenylphenyl]indenyl)₂zirconium dimethyl;
dimethylsiladiyl(2-n-propyl, 4-[3′,5′-di-phenylphenyl]indenyl)₂zirconium dimethyl;
dimethylsiladiyl(2-iso-propyl, 4-[3′,5′-di-phenylphenyl]indenyl)₂zirconium dimethyl;
dimethylsiladiyl(2-n-butyl, 4-[3′,5′-di-phenylphenyl]indenyl)₂zirconium dimethyl;
dimethylsiladiyl(2-iso-butyl, 4-[3′,5′-di-phenylphenyl]indenyl)₂zirconium dimethyl;
dimethylsiladiyl(2-sec-butyl, 4-[3′,5′-di-phenylphenyl]indenyl)₂zirconium dimethyl;
dimethylsiladiyl(2-tert-butyl, 4-[3′,5′-di-phenylphenyl]indenyl)₂zirconium dimethyl;
dimethylsiladiyl(2-methyl, 4-[3′,5′-di-phenylphenyl]indenyl)₂hafnium dimethyl;
dimethylsiladiyl(2-ethyl, 4-[3′,5′-di-phenylphenyl]indenyl)₂hafnium dimethyl;
dimethylsiladiyl(2-n-propyl, 4-[3′,5′-di-phenylphenyl]indenyl)₂hafnium dimethyl;
dimethylsiladiyl(2-iso-propyl, 4-[3′,5′-di-phenylphenyl]indenyl)₂hafnium dimethyl;
dimethylsiladiyl(2-n-butyl, 4-[3′,5′-di-phenylphenyl]indenyl)₂hafnium dimethyl;
dimethylsiladiyl(2-iso-butyl, 4-[3′,5′-di-phenylphenyl]indenyl)₂hafnium dimethyl;
dimethylsiladiyl(2-sec-butyl, 4-[3′,5′-di-phenylphenyl]indenyl)₂hafnium dimethyl;
dimethylsiladiyl(2-tert-butyl, 4-[3′,5′-di-phenylphenyl]indenyl)₂hafnium dimethyl;
9-silafluorendiyl(2-methyl, 4-[3′,5′-di-phenylphenyl]indenyl)₂zirconium dimethyl;
9-silafluorendiyl(2-ethyl, 4-[3′,5′-di-phenylphenyl]indenyl)₂zirconium dimethyl;
9-silafluorendiyl(2-n-propyl, 4-[3′,5′-di-phenylphenyl]indenyl)₂zirconium dimethyl;
9-silafluorendiyl(2-iso-propyl, 4-[3′,5′-di-phenylphenyl]indenyl)₂zirconium dimethyl;
9-silafluorendiyl(2-n-butyl, 4-[3′,5′-di-phenylphenyl]indenyl)₂zirconium dimethyl;
9-silafluorendiyl(2-iso-butyl, 4-[3′,5′-di-phenylphenyl]indenyl)₂zirconium dimethyl;
9-silafluorendiyl(2-sec-butyl, 4-[3′,5′-di-phenylphenyl]indenyl)₂zirconium dimethyl;
9-silafluorendiyl(2-tert-butyl, 4-[3′,5′-di-phenylphenyl]indenyl)₂zirconium dimethyl;
9-silafluorendiyl(2-methyl, 4-[3′,5′-di-phenylphenyl]indenyl)₂hafnium dimethyl;
9-silafluorendiyl(2-ethyl, 4-[3′,5′-di-phenylphenyl]indenyl)₂hafnium dichloride;
9-silafluorendiyl(2-n-propyl, 4-[3′,5′-di-phenylphenyl]indenyl)₂hafnium dimethyl;
9-silafluorendiyl(2-iso-propyl, 4-[3′,5′-di-phenylphenyl]indenyl)₂hafnium dimethyl;
9-silafluorendiyl(2-n-butyl, 4-[3′,5′-di-phenylphenyl]indenyl)₂hafnium dimethyl;
9-silafluorendiyl(2-iso-butyl, 4-[3′,5′-di-phenylphenyl]indenyl)₂hafnium dimethyl;
9-silafluorendiyl(2-sec-butyl, 4-[3′,5′-di-phenylphenyl]indenyl)₂hafnium dimethyl;
9-silafluorendiyl(2-tert-butyl, 4-[3′,5′-di-phenylphenyl]indenyl)₂hafnium dimethyl;
dimethylamidoborane(2-methyl, 4-[3′,5′-di-tbutylphenyl]indenyl)₂zirconium dichloride;
dimethylamidoborane(2-ethyl, 4-[3′,5′-di-tbutylphenyl]indenyl)₂zirconium dichloride;
dimethylamidoborane(2-n-propyl, 4-[3′,5′-di-tbutylphenyl]indenyl)₂zirconium dichloride;
dimethylamidoborane(2-iso-propyl, 4-[3′,5′-di-tbutylphenyl]indenyl)₂zirconium dichloride;
dimethylamidoborane(2-n-butyl, 4-[3′,5′-di-tbutylphenyl]indenyl)₂zirconium dichloride;
dimethylamidoborane(2-iso-butyl, 4-[3′,5′-di-tbutylphenyl]indenyl)₂zirconium dichloride;
dimethylamidoborane(2-sec-butyl, 4-[3′,5′-di-tbutylphenyl]indenyl)₂zirconium dichloride;
dimethylamidoborane(2-tert-butyl, 4-[3′,5′-di-tbutylphenyl]indenyl)₂zirconium dichloride;
dimethylamidoborane(2-ethyl, 4-[3′,5′-bis-trifluoromethylphenyl]indenyl)₂zirconium dichloride;
dimethylamidoborane(2-n-propyl, 4-[3′,5′-bis-trifluoromethylphenyl]indenyl)₂zirconium dichloride;
dimethylamidoborane(2-iso-propyl, 4-[3′,5′-bis-trifluoromethylphenyl]indenyl)₂zirconium dichloride;
dimethylamidoborane(2-n-butyl, 4-[3′,5′-bis-trifluoromethylphenyl]indenyl)₂zirconium dichloride;
dimethylamidoborane(2-iso-butyl, 4-[3′,5′-bis-trifluoromethylphenyl]indenyl)₂zirconium dichloride;
dimethylamidoborane(2-sec-butyl, 4-[3′,5′-bis-trifluoromethylphenyl]indenyl)₂zirconium dichloride;
dimethylamidoborane(2-tert-butyl, 4-[3′,5′-bis-trifluoromethylphenyl]indenyl)₂zirconium dichloride;
dimethylamidoborane(2-ethyl, 4-[3′,5′-di-iso-propylphenyl]indenyl)₂zirconium dichloride;
dimethylamidoborane(2-n-propyl, 4-[3′,5′-di-iso-propylphenyl]indenyl)₂zirconium dichloride
dimethylamidoborane(2-iso-propyl, 4-[3′,5′-di-iso-propylphenyl]indenyl)₂zirconium dichloride;
dimethylamidoborane(2-n-butyl, 4-[3′,5′-di-iso-propylphenyl]indenyl)₂zirconium dichloride;
dimethylamidoborane(2-iso-butyl, 4-[3′,5′-di-iso-propylphenyl]indenyl)₂zirconium dichloride;
dimethylamidoborane(2-sec-butyl, 4-[3′,5′-di-iso-propylphenyl]indenyl)₂zirconium dichloride;
dimethylamidoborane(2-tert-butyl, 4-[3′,5′-di-iso-propylphenyl]indenyl)₂zirconium dichloride;
dimethylamidoborane(2-methyl, 4-[3′,5′-di-phenylphenyl]indenyl)₂zirconium dichloride;
dimethylamidoborane(2-ethyl, 4-[3′,5′-di-phenylphenyljindenyl)₂zirconium dichloride;
dimethylamidoborane(2-n-propyl, 4-[3′,5′-di-phenylphenyl]indenyl)₂zirconium dichloride;
dimethylamidoborane(2-iso-propyl, 4-[3′,5′-di-phenylphenyl]indenyl)₂zirconium dichloride;
dimethylamidoborane(2-n-butyl, 4-[3′,5′-di-phenylphenyl]indenyl)₂zirconium dichloride;
dimethylamidoborane(2-iso-butyl, 4-[3′,5′-di-phenylphenyl]indenyl)₂zirconium dichloride;
dimethylamidoborane(2-sec-butyl, 4-[3′,5′-di-phenylphenyl]indenyl)₂zirconium dichloride;
dimethylamidoborane(2-tert-butyl, 4-[3′,5′-di-phenylphenyl]indenyl)₂zirconium dichloride;
dimethylamidoborane(2-methyl, 4-[3 ′,5′-di-tbutylphenyl]indenyl)₂ zirconium dimethyl;
dimethylamidoborane(2-ethyl, 4-[3′,5′-di-tbutylphenyl]indenyl)₂zirconium dimethyl;
dimethylamidoborane(2-n-propyl, 4-[3′,5′-di-tbutylphenyl]indenyl)₂zirconium dimethyl;
dimethylamidoborane(2-iso-propyl, 4-[3′,5′-di-tbutylphenyl]indenyl)₂zirconium dimethyl;
dimethylamidoborane(2-n-butyl, 4-[3′,5′-di-tbutylphenyl]indenyl)₂zirconium dimethyl;
dimethylamidoborane(2-iso-butyl, 4-[3′,5′-di-tbutylphenyl]indenyl)₂zirconium dimethyl;
dimethylamidoborane(2-sec-butyl, 4-[3′,5′-di-tbutylphenyl]indenyl)₂zirconium dimethyl;
dimethylamidoborane(2-tert-butyl, 4-[3′,5′-di-tbutylphenyl]indenyl)₂zirconium dimethyl;
dimethylamidoborane(2-ethyl, 4-[3′,5′-bis-trifluoromethylphenyl]indenyl)₂zirconium dimethyl;
dimethylamidoborane(2-n-propyl, 4-[3′,5′-bis-trifluoromethylphenyl]indenyl)₂zirconium dimethyl;
dimethylamidoborane(2-iso-propyl, 4-[3′,5′-bis-trifluoromethylphenyl]indenyl)₂zirconium dimethyl;
dimethylamidoborane(2-n-butyl, 4-[3′,5′-bis-trifluoromethylphenyl]indenyl)₂zirconium dimethyl;
dimethylamidoborane(2-iso-butyl, 4-[3′,5′-bis-trifluoromethylphenyl]indenyl)₂zirconium dimethyl;
dimethylamidoborane(2-sec-butyl, 4-[3′,5′-bis-trifluoromethylphenyl]indenyl)₂zirconium dimethyl;
dimethylamidoborane(2-tert-butyl, 4-[3′,5′-bis-trifluoromethylphenyl]indenyl)₂zirconium dimethyl;
dimethylamidoborane(2-ethyl, 4-[3′,5′-di-iso-propylphenyl]indenyl)₂zirconium dimethyl;
dimethylamidoborane(2-n-propyl, 4-[3′,5′-di-iso-propylphenyl]indenyl)₂zirconium dimethyl
dimethylamidoborane(2-iso-propyl, 4-[3′,5′-di-iso-propylphenyl]indenyl)₂zirconium dimethyl;
dimethylamidoborane(2-n-butyl, 4-[3′,5′-di-iso-propylphenyl]indenyl)₂zirconium dimethyl;
dimethylamidoborane(2-iso-butyl, 4-[3′,5′-di-iso-propylphenyl]indenyl)₂zirconium dimethyl;
dimethylamidoborane(2-sec-butyl, 4-[3′,5′-di-iso-propylphenyl]indenyl)₂zirconium dimethyl;
dimethylamidoborane(2-tert-butyl, 4-[3′,5′-di-iso-propylphenyl]indenyl)₂zirconium dimethyl;
dimethylamidoborane(2-methyl, 4-[3′,5′-di-phenylphenyl]indenyl)₂zirconium dimethyl;
dimethylamidoborane(2-ethyl, 4-[3′,5′-di-phenylphenyl]indenyl)₂zirconium dimethyl;
dimethylamidoborane(2-n-propyl, 4-[3′,5′-di-phenylphenyl]indenyl)₂zirconium dimethyl;
dimethylamidoborane(2-iso-propyl, 4-[3′,5′-di-phenylphenyl]indenyl)₂zirconium dimethyl;
dimethylamidoborane(2-n-butyl, 4-[3′,5′-di-phenylphenyl]indenyl)₂zirconium dimethyl;
dimethylamidoborane(2-iso-butyl, 4-[3′,5′-di-phenylphenyl]indenyl)₂zirconium dimethyl;
dimethylamidoborane(2-sec-butyl, 4-[3′,5′-di-phenylphenyl]indenyl)₂zirconium dimethyl;
dimethylamidoborane(2-tert-butyl, 4-[3′,5′-di-phenylphenyl]indenyl)₂zirconium dimethyl;
diisopropylamidoborane(2-methyl, 4-[3′,5′-di-tbutylphenyl]indenyl)₂zirconium dichloride;
diisopropylamidoborane(2-ethyl, 4-[3′,5′-di-tbutylphenyl]indenyl)₂zirconium dichloride;
diisopropylamidoborane(2-n-propyl, 4-[3′,5′-di-tbutylphenyl]indenyl)₂zirconium dichloride;
diisopropylamidoborane(2-iso-propyl, 4-[3′,5′-di-tbutylphenyl]indenyl)₂zirconium dichloride;
diisopropylamidoborane(2-n-butyl, 4-[3′,5′-di-tbutylphenyl]indenyl)₂zirconium dichloride;
diisopropylamidoborane(2-iso-butyl, 4-[3′,5′-di-tbutylphenyl]indenyl)₂zirconium dichloride;
diisopropylamidoborane(2-sec-butyl, 4-[3′,5′-di-tbutylphenyl]indenyl)₂zirconium dichloride;
diisopropylamidoborane(2-tert-butyl, 4-[3′,5′-di-tbutylphenyl]indenyl)₂zirconium dichloride;
diisopropylamidoborane(2-ethyl, 4-[3′,5′-bis-trifluoromethylphenyl]indenyl)₂zirconium dichloride;
diisopropylamidoborane(2-n-propyl, 4-[3′,5′-bis-trifluoromethylphenyl]indenyl)₂zirconium dichloride;
diisopropylamidoborane(2-iso-propyl, 4-[3′,5′-bis-trifluoromethylphenyl]indenyl)₂zirconium dichloride;
diisopropylamidoborane(2-n-butyl, 4-[3′,5′-bis-trifluoromethylphenyl]indenyl)₂zirconium dichloride;
diisopropylamidoborane(2-iso-butyl, 4-[3′,5′-bis-trifluoromethylphenyl]indenyl)₂zirconium dichloride;
diisopropylamidoborane(2-sec-butyl, 4-[3′,5′-bis-trifluoromethylphenyl]indenyl)₂zirconium dichloride;
diisopropylamidoborane(2-tert-butyl, 4-[3′,5′-bis-trifluoromethylphenyl]indenyl)₂zirconium dichloride;
diisopropylamidoborane(2-ethyl, 4-[3′,5′-di-iso-propylphenyl]indenyl)₂zirconium dichloride;
diisopropylamidoborane(2-n-propyl, 4-[3′,5′-di-iso-propylphenyl]indenyl)₂zirconium dichloride
diisopropylamidoborane(2-iso-propyl, 4-[3′,5′-di-iso-propylphenyl]indenyl)₂zirconium dichloride;
diisopropylamidoborane(2-n-butyl, 4-[3′,5′-di-iso-propylphenyl]indenyl)₂zirconium dichloride;
diisopropylamidoborane(2-iso-butyl, 4-[3′,5′-di-iso-propylphenyl]indenyl)₂zirconium dichloride;
diisopropylamidoborane(2-sec-butyl, 4-[3′,5′-di-iso-propylphenyl]indenyl)₂zirconium dichloride;
diisopropylamidoborane(2-tert-butyl, 4-[3′,5′-di-iso-propylphenyl]indenyl)₂zirconium dichloride;
diisopropylamidoborane(2-methyl, 4-[3′,5′-di-phenylphenyl]indenyl)₂zirconium dichloride;
diisopropylamidoborane(2-ethyl, 4-[3′,5′-di-phenylphenyl]indenyl)₂zirconium dichloride;
diisopropylamidoborane(2-n-propyl, 4-[3′,5′-di-phenylphenyl]indenyl)₂zirconium dichloride;
diisopropylamidoborane(2-iso-propyl, 4-[3′,5′-di-phenylphenyl]indenyl)₂zirconium dichloride;
diisopropylamidoborane(2-n-butyl, 4-[3′,5′-di-phenylphenyl]indenyl)₂zirconium dichloride;
diisopropylamidoborane(2-iso-butyl, 4-[3′,5′-di-phenylphenyl]indenyl)₂zirconium dichloride;
diisopropylamidoborane(2-sec-butyl, 4-[3′,5′-di-phenylphenyl]indenyl)₂zirconium dichloride;
diisopropylamidoborane(2-tert-butyl, 4-[3′,5′-di-phenylphenyl]indenyl)₂zirconium dichloride;
diisopropylamidoborane(2-methyl, 4-[3′,5′-di-tbutylphenyl]indenyl)₂zirconium dimethyl;
diisopropylamidoborane(2-ethyl, 4-[3′,5′-di-tbutylphenyl]indenyl)₂zirconium dimethyl;
diisopropylamidoborane(2-n-propyl, 4-[3′,5′-di-tbutylphenyl]indenyl)₂zirconium dimethyl;
diisopropylamidoborane(2-iso-propyl, 4-[3′,5′-di-tbutylphenyl]indenyl)₂zirconium dimethyl;
diisopropylamidoborane(2-n-butyl, 4-[3′,5′-di-tbutylphenyl]indenyl)₂zirconium dimethyl;
diisopropylamidoborane(2-iso-butyl, 4-[3′,5′-di-tbutylphenyl]indenyl)₂zirconium dimethyl;
diisopropylamidoborane(2-sec-butyl, 4-[3′,5′-di-tbutylphenyl]indenyl)₂zirconium dimethyl;
diisopropylamidoborane(2-tert-butyl, 4-[3′,5′-di-tbutylphenyl]indenyl)₂zirconium dimethyl;
diisopropylamidoborane(2-ethyl, 4-[3′,5′-bis-trifluoromethylphenyl]indenyl)₂zirconium dimethyl;
diisopropylamidoborane(2-n-propyl, 4-[3′,5′-bis-trifluoromethylphenyl]indenyl)₂zirconium dimethyl;
diisopropylamidoborane(2-iso-propyl, 4-[3′,5′-bis-trifluoromethylphenyl]indenyl)₂zirconium dimethyl;
diisopropylamidoborane(2-n-butyl, 4-[3 ′,5′-bis-trifluoromethylphenyl]indenyl)₂zirconium dimethyl;
diisopropylamidoborane(2-iso-butyl, 4-[3′,5′-bis-trifluoromethylphenyl]indenyl)₂zirconium dimethyl;
diisopropylamidoborane(2-sec-butyl, 4-[3′,5′-bis-trifluoromethylphenyl]indenyl)₂zirconium dimethyl;
diisopropylamidoborane(2-tert-butyl, 4-[3′,5′-bis-trifluoromethylphenyl]indenyl)₂zirconium dimethyl;
diisopropylamidoborane(2-ethyl, 4-[3′,5′-di-iso-propylphenyl]indenyl)₂zirconium dimethyl;
diisopropylamidoborane(2-n-propyl, 4-[3′,5′-di-iso-propylphenyl]indenyl)₂zirconium dimethyl
diisopropylamidoborane(2-iso-propyl, 4-[3′,5′-di-iso-propylphenyl]indenyl)₂zirconium dimethyl;
diisopropylamidoborane(2-n-butyl, 4-[3′,5′-di-iso-propylphenyl]indenyl)₂zirconium dimethyl;
diisopropylamidoborane(2-iso-butyl, 4-[3′,5′-di-iso-propylphenyl]indenyl)₂zirconium dimethyl;
diisopropylamidoborane(2-sec-butyl, 4-[3′,5′-di-iso-propylphenyl]indenyl)₂zirconium dimethyl;
diisopropylamidoborane(2-tert-butyl, 4-[3′,5′-di-iso-propylphenyl]indenyl)₂zirconium dimethyl;
diisopropylamidoborane(2-methyl, 4-[3′,5′-di-phenylphenyl]indenyl)₂zirconium dimethyl;
diisopropylamidoborane(2-ethyl, 4-[3′,5′-di-phenylphenyl]indenyl)₂zirconium dimethyl;
diisopropylamidoborane(2-n-propyl, 4-[3′,5′-di-phenylphenyl]indenyl)₂zirconium dimethyl;
diisopropylamidoborane(2-iso-propyl, 4-[3′,5′-di-phenylphenyl]indenyl)₂zirconium dimethyl;
diisopropylamidoborane(2-n-butyl, 4-[3′,5′-di-phenylphenyl]indenyl)₂zirconium dimethyl;
diisopropylamidoborane(2-iso-butyl, 4-[3′,5′-di-phenylphenyl]indenyl)₂zirconium dimethyl;
diisopropylamidoborane(2-sec-butyl, 4-[3′,5′-di-phenylphenyl]indenyl)₂zirconium dimethyl;
diisopropylamidoborane(2-tert-butyl, 4-[3′,5′-di-phenylphenyl]indenyl)₂zirconium dimethyl;
bis(trimethylsilyl)amidoborane(2-methyl, 4-[3′,5′-di-tbutylphenyl]indenyl)₂zirconium dichloride;
bis(trimethylsilyl)amidoborane(2-ethyl, 4-[3 ′,5′-di-tbutylphenyl]indenyl)₂zirconium dichloride;
bis(trimethylsilyl)amidoborane(2-n-propyl, 4-[3′,5′-di-tbutylphenyl]indenyl)₂zirconium dichloride;
bis(trimethylsilyl)amidoborane(2-iso-propyl, 4-[3′,5′-di-tbutylphenyl]indenyl)₂zirconium dichloride;
bis(trimethylsilyl)amidoborane(2-n-butyl, 4-[3′,5′-di-tbutylphenyl]indenyl)₂zirconium dichloride;
bis(trimethylsilyl)amidoborane(2-iso-butyl, 4-[3′,5′-di-tbutylphenyl]indenyl)₂zirconium dichloride;
bis(trimethylsilyl)amidoborane(2-sec-butyl, 4-[3′,5′-di-tbutylphenyl]indenyl)₂zirconium dichloride;
bis(trimethylsilyl)amidoborane(2-tert-butyl, 4-[3′,5′-di-tbutylphenyl]indenyl)₂zirconium dichloride;
bis(trimethylsilyl)amidoborane(2-ethyl, 4-[3′,5′-bis-trifluoromethylphenyl]indenyl)₂zirconium dichloride;
bis(trimethylsilyl)amidoborane(2-n-propyl, 4-[3′,5′-bis-trifluoromethylphenyl]indenyl)₂zirconium dichloride;
bis(trimethylsilyl)amidoborane(2-iso-propyl, 4-[3′,5′-bis-trifluoromethylphenyl]indenyl)₂zirconium dichloride;
bis(trimethylsilyl)amidoborane(2-n-butyl, 4-[3′,5′-bis-trifluoromethylphenyl]indenyl)₂zirconium dichloride;
bis(trimethylsilyl)amidoborane(2-iso-butyl, 4-[3′,5′-bis-trifluoromethylphenyl]indenyl)₂zirconium dichloride;
bis(trimethylsilyl)amidoborane(2-sec-butyl, 4-[3′,5′-bis-trifluoromethylphenyl]indenyl)₂zirconium dichloride;
bis(trimethylsilyl)amidoborane(2-tert-butyl, 4-[3′,5′-bis-trifluoromethylphenyl]indenyl)₂zirconium dichloride;
bis(trimethylsilyl)amidoborane(2-ethyl, 4-[3′,5′-di-iso-propylphenyl]indenyl)₂zirconium dichloride;
bis(trimethylsilyl)amidoborane(2-n-propyl, 4-[3′,5′-di-iso-propylphenyl]indenyl)₂zirconium dichloride
bis(trimethylsilyl)amidoborane(2-iso-propyl, 4-[3′,5′-di-iso-propylphenyl]indenyl)₂zirconium dichloride;
bis(trimethylsilyl)amidoborane(2-n-butyl, 4-[3′,5′-di-iso-propylphenyl]indenyl)₂zirconium dichloride;
bis(trimethylsilyl)amidoborane(2-iso-butyl, 4-[3′,5′-di-iso-propylphenyl]indenyl)₂zirconium dichloride;
bis(trimethylsilyl)amidoborane(2-sec-butyl, 4-[3′,5′-di-iso-propylphenyl]indenyl)₂zirconium dichloride;
bis(trimethylsilyl)amidoborane(2-tert-butyl, 4-[3′,5′-di-iso-propylphenyl]indenyl)₂zirconium dichloride;
bis(trimethylsilyl)amidoborane(2-methyl, 4-[3′,5′-di-phenylphenyl]indenyl)₂zirconium dichloride;
bis(trimethylsilyl)amidoborane(2-ethyl, 4-[3′,5′-di-phenylphenyl]indenyl)₂zirconium dichloride;
bis(trimethylsilyl)amidoborane(2-n-propyl, 4-[3′,5′-di-phenylphenyl]indenyl)₂zirconium dichloride;
bis(trimethylsilyl)amidoborane(2-iso-propyl, 4-[3′,5′-di-phenylphenyl]indenyl)₂zirconium dichloride;
bis(trimethylsilyl)amidoborane(2-n-butyl, 4-[3′,5′-di-phenylphenyl]indenyl)₂zirconium dichloride;
bis(trimethylsilyl)amidoborane(2-iso-butyl, 4-[3′,5′-di-phenylphenyl]indenyl)₂zirconium dichloride;
bis(trimethylsilyl)amidoborane(2-sec-butyl, 4-[3′,5′-di-phenylphenyl]indenyl)₂zirconium dichloride;
bis(trimethylsilyl)amidoborane(2-tert-butyl, 4-[3′,5′-di-phenylphenyl]indenyl)₂zirconium dichloride;
bis(trimethylsilyl)amidoborane(2-methyl, 4-[3′,5′-di-tbutylphenyl]indenyl)₂zirconium dimethyl;
bis(trimethylsilyl)amidoborane(2-ethyl, 4-[3′,5′-di-tbutylphenyl]indenyl)₂zirconium dimethyl;
bis(trimethylsilyl)amidoborane(2-n-propyl, 4-[3′,5′-di-tbutylphenyl]indenyl)₂zirconium dimethyl;
bis(trimethylsilyl)amidoborane(2-iso-propyl, 4-[3′,5′-di-tbutylphenyl]indenyl)₂zirconium dimethyl;
bis(trimethylsilyl)amidoborane(2-n-butyl, 4-[3′,5′-di-tbutylphenyl]indenyl)₂zirconium dimethyl;
bis(trimethylsilyl)amidoborane(2-iso-butyl, 4-[3′,5′-di-tbutylphenyl]indenyl)₂zirconium dimethyl;
bis(trimethylsilyl)amidoborane(2-sec-butyl, 4-[3′,5′-di-tbutylphenyl]indenyl)₂zirconium dimethyl;
bis(trimethylsilyl)amidoborane(2-tert-butyl, 4-[3′,5′-di-tbutylphenyl]indenyl)₂zirconium dimethyl;
bis(trimethylsilyl)amidoborane(2-ethyl, 4-[3′,5′-bis-trifluoromethylphenyl]indenyl)₂zirconium dimethyl;
bis(trimethylsilyl)amidoborane(2-n-propyl, 4-[3′,5′-bis-trifluoromethylphenyl]indenyl)₂zirconium dimethyl;
bis(trimethylsilyl)amidoborane(2-iso-propyl, 4-[3′,5′-bis-trifluoromethylphenyl]indenyl)₂zirconium dimethyl;
bis(trimethylsilyl)amidoborane(2-n-butyl, 4-[3′,5′-bis-trifluoromethylphenyl]indenyl)₂zirconium dimethyl;
bis(trimethylsilyl)amidoborane(2-iso-butyl, 4-[3′,5′-bis-trifluoromethylphenyl]indenyl)₂zirconium dimethyl;
bis(trimethylsilyl)amidoborane(2-sec-butyl, 4-[3′,5′-bis-trifluoromethylphenyl]indenyl)₂zirconium dimethyl;
bis(trimethylsilyl)amidoborane(2-tert-butyl, 4-[3′,5′-bis-trifluoromethylphenyl]indenyl)₂zirconium dimethyl;
bis(trimethylsilyl)amidoborane(2-ethyl, 4-[3′,5′-di-iso-propylphenyl]indenyl)₂zirconium dimethyl;
bis(trimethylsilyl)amidoborane(2-n-propyl, 4-[3′,5′-di-iso-propylphenyl]indenyl)₂zirconium dimethyl
bis(trimethylsilyl)amidoborane(2-iso-propyl, 4-[3′,5′-di-iso-propylphenyl]indenyl)₂zirconium dimethyl;
bis(trimethylsilyl)amidoborane(2-n-butyl, 4-[3′,5′-di-iso-propylphenyl]indenyl)₂zirconium dimethyl;
bis(trimethylsilyl)amidoborane(2-iso-butyl, 4-[3′,5′-di-iso-propylphenyl]indenyl)₂zirconium dimethyl;
bis(trimethylsilyl)amidoborane(2-sec-butyl, 4-[3′,5′-di-iso-propylphenyl]indenyl)₂zirconium dimethyl;
bis(trimethylsilyl)amidoborane(2-tert-butyl, 4-[3′,5′-di-iso-propylphenyl]indenyl)₂zirconium dimethyl;
bis(trimethylsilyl)amidoborane(2-methyl, 4-[3′,5′-di-phenylphenyl]indenyl)₂zirconium dimethyl;
bis(trimethylsilyl)amidoborane(2-ethyl, 4-[3′,5′-di-phenylphenyl]indenyl)₂zirconium dimethyl;
bis(trimethylsilyl)amidoborane(2-n-propyl, 4-[3′,5′-di-phenylphenyl]indenyl)₂zirconium dimethyl;
bis(trimethylsilyl)amidoborane(2-iso-propyl, 4-[3′,5′-di-phenylphenyl]indenyl)₂zirconium dimethyl;
bis(trimethylsilyl)amidoborane(2-n-butyl, 4-[3′,5′-di-phenylphenyl]indenyl)₂zirconium dimethyl;
bis(trimethylsilyl)amidoborane(2-iso-butyl, 4-[3′,5′-di-phenylphenyl]indenyl)₂zirconium dimethyl;
bis(trimethylsilyl)amidoborane(2-sec-butyl, 4-[3′,5′-di-phenylphenyl]indenyl)₂zirconium dimethyl; and
bis(trimethylsilyl)amidoborane(2-tert-butyl, 4-[3′,5′-di-phenylphenyl]indenyl)₂zirconium dimethyl.
   Activator and Activation Methods

The metal compounds described above are preferably combined with one or more activators to form an olefin polymerization catalyst system. The terms “cocatalyst” and “activator” are used herein interchangeably and are defined to be any compound or component or method which can activate any of the catalyst compounds of the invention as described above. Non-limiting examples of activators may include a Lewis acid or a non-coordinating ionic activator or ionizing activator or any other compound including Lewis bases, aluminum alkyls, conventional-type cocatalysts and combinations thereof, that can convert a neutral catalyst compound to a catalytically active cation. It is within the scope of this invention to use alumoxane or modified alumoxane as an activator, and/or to also use ionizing activators, neutral or ionic, such as tri (n-butyl) ammonium tetrakis (pentafluorophenyl) boron, a trisperfluorophenyl boron metalloid precursor or a trisperfluoronaphtyl boron metalloid precursor, polyhalogenated heteroborane anions (WO 98/43983) or combination thereof, that would ionize the catalyst metal compound.

In one embodiment, an activation method using ionizing ionic compounds not containing an active proton but capable of producing a catalyst cation and their non-coordinating anion are also contemplated, and are described in EP-A-0 426 637, EP-A-0 573 403 and U.S. Pat. No. 5,387,568.

Descriptions of ionic catalysts for coordination polymerization comprised of metallocene cations activated by non-coordinating anions appear in the early work in EP-A-0 277 003, EP-A-0 277 004 and U.S. Pat. No. 5,198,401 and WO-A-92/00333. These teach a preferred method of preparation wherein metallocenes (bisCp and monoCp) are protonated by an anion precursor such that an alkyl/hydride group is abstracted from a transition metal to make it both cationic and charge-balanced by the non-coordinating anion. The term “noncoordinating anion” means an anion which either does not coordinate to said cation or which is only weakly coordinated to said cation thereby remaining sufficiently labile to be displaced by a neutral Lewis base. “Compatible” noncoordinating anions are those which are not degraded to neutrality when the initially formed complex decomposes. Further, the anion will not transfer an anionic substituent or fragment to the cation so as to cause it to form a neutral four coordinate metallocene compound and a neutral by-product from the anion. Noncoordinating anions useful in accordance with this invention are those which are compatible, stabilize the metallocene cation in the sense of balancing its ionic charge, yet retain sufficient lability to permit displacement by an ethylenically or acetylenically unsaturated monomer during polymerization.

The use of ionizing ionic compounds not containing an active proton but capable of producing both the active metallocene cation and an noncoordinating anion is also known. See, EP-A-0 426 637 and EP-A-0 573 403. An additional method of making the ionic catalysts uses ionizing anion pre-cursors which are initially neutral Lewis acids but form the cation and anion upon ionizing reaction with the metallocene compounds, for example, the use of tris(pentafluorophenyl) boron. See EP-A-0 520 732. Ionic catalysts for addition polymerization can also be prepared by oxidation of the metal centers of transition metal compounds by anion pre-cursors containing metallic oxidizing groups along with the anion groups, see EP-A-0 495 375.

Where the metal ligands include halogen moieties (for example, biscyclopentadienyl zirconium dichloride) which are not capable of ionizing abstraction under standard conditions, they can be converted via known alkylation reactions with organometallic compounds such as lithium or aluminum hydrides or alkyls, alkylalumoxanes, Grignard reagents, etc. See EP-A-0 500 944 and EP-A1-0 570 982 for in situ processes describing the reaction of alkyl aluminum compounds with dihalo-substituted metallocene compounds prior to or with the addition of activating anionic compounds.

Preferred activators include those described in European publications EP-A-0 570 982, EP-A-0 520 732, EP-A-0 495 375, EP-B1-0 500 944, EP-A-0 277 003 and EP-A-0 277 004, and U.S. Pat. Nos. 5,153,157, 5,198,401, 5,066,741, 5,206,197, 5,241,025, 5,384,299 and 5,502,124.

Other activators include those described in PCT publication WO 98/07515 such as tris (2, 2′, 2″-nonafluorobiphenyl)fluoroaluminate.

Combinations of activators are also contemplated by the invention, for example, alumoxanes and ionizing activators in combinations, see for example, EP-B1 0 573 120, PCT publications WO 94/07928 and WO 95/14044 and U.S. Pat. Nos. 5,153,157 and 5,453,410.

WO 98/09996 describes activating metallocene catalyst compounds with perchlorates, periodates and iodates including their hydrates. WO 98/30602 and WO 98/30603 describe the use of lithium (2,2′-bisphenyl-ditrimethylsilicate)⊚4THF as an activator for a bulky ligand metallocene catalyst compound. WO 99/18135 describes the use of organo-boron-aluminum activators. EP-B1-0 781 299 describes using a silylium salt in combination with a non-coordinating compatible anion. Also, methods of activation such as using radiation (see EP-B1-0 615 981), electro-chemical oxidation, and the like are also contemplated as activating methods for the purposes of rendering the neutral metallocene catalyst compound or precursor to a metallocene-type cation capable of polymerizing olefins. Other activators or methods for activating a metallocene catalyst compound are described in for example, U.S. Pat. Nos. 5,849,852, 5,859,653 and 5,869,723 and WO 98/32775, WO 99/42467 (dioctadecylmethylammonium-bis(tris(pentafluorophenyl)borane)benzimidazolide).

There are a variety of methods for preparing alumoxane and modified alumoxanes, non-limiting examples of which are described in U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,157,137, 5,103,031, 5,391,793, 5,391,529, 5,693,838, 5,731,253, 5,731,451, 5,744,656, 5,847,177, 5,854,166, 5,856,256 and 5,939,346 and European publications EP-A-0 561 476, EP-B1-0 279 586, EP-A-0 594-218 and EP-B1-0 586 665, and PCT publication WO 94/10180. It may be preferable to use a visually clear methylalumoxane. A cloudy or gelled alumoxane can be filtered to produce a clear solution or clear alumoxane can be decanted from the cloudy solution.

Organoaluminum compounds useful as activators (or scavengers) include trimethylaluminum, triethylaluminum, triisobutylaluminum, tri-n-hexylaluminum, tri-n-octylaluminum and the like.

In general the combined metal compounds and the activator are combined in ratios of about 1000:1 to about 0.5:1. In a preferred embodiment, the metal compounds and the activator are combined in a ratio of about 300:1 to about 1:1, preferably about 150:1 to about 1:1. For boranes, borates, aluminates, etc. the ratio is preferably about 1:1 to about 10:1 and for alkyl aluminum compounds (such as diethylaluminum chloride combined with water) the ratio is preferably about 0.5:1 to about 10:1.

Polymerization Processes

The catalysts and catalyst systems described above are suitable for use in a solution, gas or slurry polymerization process or a combination thereof.

In one embodiment, this invention is directed toward the solution, slurry or gas phase polymerization reactions involving the polymerization of propylene with a branched olefin, preferably a branched alpha olefin. In another embodiment, this invention is directed toward the solution, slurry or gas phase polymerization reactions involving the polymerization of propylene with more than one branched olefins, preferably comprising at least one branched alpha olefin. These mixed feeds comprising two or more branched olefins preferably comprise monomers having from 2 to 30 carbon atoms, preferably 2-20 carbon atoms, and more preferably 2 to 18 carbon atoms. In another embodiment, both a homopolymer of propylene and a copolymer of propylene and at least one of the branched olefin monomers listed above are produced.

Gas Phase Polymerization

Typically in a gas phase polymerization process, a continuous cycle is employed wherein one part of the cycle of a reactor system, a cycling gas stream, otherwise known as a recycle stream or fluidizing medium, is heated in the reactor by the heat of polymerization. This heat is removed from the recycle composition in another part of the cycle by a cooling system external to the reactor. Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See for example U.S. Pat. Nos. 4,543,399, 4,588,790, 5,028,670, 5,317,036, 5,352,749, 5,405,922, 5,436,304, 5,453,471, 5,462,999, 5,616,661 and 5,668,228.)

The reactor pressure in a gas phase process may vary from about 10 psig (69 kPa) to about 500 psig (3448 kPa), preferably from about 100 psig (690 kPa) to about 500 psig (3448 kPa), preferably in the range of from about 200 psig (1379 kPa) to about 400 psig (2759 kPa), more preferably in the range of from about 250 psig (1724 kPa) to about 350 psig (2414 kPa).

The reactor temperature in the gas phase process may vary from about 30° C. to about 120° C., preferably from about 60° C. to about 115° C., more preferably in the range of from about 70° C. to 110° C., and most preferably in the range of from about 70° C. to about 95° C.

In a preferred embodiment, the reactor utilized in the present invention is capable and the process of the invention is producing greater than 500 lbs of polymer per hour (227 Kg/hr) to about 200,000 lbs/hr (90,900 Kg/hr) or higher of polymer, preferably greater than 1000 lbs/hr (455 Kg/hr), more preferably greater than 10,000 lbs/hr (4540 Kg/hr), even more preferably greater than 25,000 lbs/hr (11,300 Kg/hr), still more preferably greater than 35,000 lbs/hr (15,900 Kg/hr), still even more preferably greater than 50,000 lbs/hr (22,700 Kg/hr) and preferably greater than 65,000 lbs/hr (29,000 Kg/hr) to greater than 100,000 lbs/hr (45,500 Kg/hr), and most preferably over 100,000 lbs/hr (45,500 Kg/hr).

Other gas phase processes contemplated by the process of the invention include those described in U.S. Pat. Nos. 5,627,242, 5,665,818 and 5,677,375, and European publications EP-A-0 794 200, EP-A-0 802 202 and EP-B-634 421.

In another preferred embodiment, the catalyst system in is liquid form and is introduced into the gas phase reactor into a resin particle lean zone. For information on how to introduce a liquid catalyst system into a fluidized bed polymerization into a particle lean zone, please see U.S. Pat. No. 5,693,727.

Slurry Phase Polymerization

A slurry polymerization process generally uses pressures in the range of from about 1 to about 50 atmospheres (15 psi to 735 psi, 103 kPa to 5068 kPa) and even greater and temperatures in the range of 0° C. to about 120° C. In a slurry polymerization, a suspension of solid, particulate polymer is formed in a liquid polymerization diluent medium to which propylene and comonomers along with catalyst are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used the process must be operated above the reaction diluent critical temperature and pressure. Preferably, a hexane or an isobutane medium is employed. In a preferred embodiment, liquid propylene is used as the polymerization medium.

In one embodiment, a preferred polymerization technique of the invention is referred to as a particle form polymerization, or a slurry process where the temperature is kept below the temperature at which the polymer goes into solution. Such technique is well known in the art, and described in for instance U.S. Pat. No. 3,248,179. The preferred temperature in the particle form process is within the range of about 185° F. (85° C.) to about 230° F. (110° C.). Two preferred polymerization methods for the slurry process are those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484.

In another embodiment, the slurry process is carried out continuously in a loop reactor. The catalyst as a slurry in isobutane or as a dry free flowing powder is injected regularly to the reactor loop, which is itself filled with circulating slurry of growing polymer particles in a diluent of isobutane containing monomer and comonomer. Hydrogen, optionally, may be added as a molecular weight control. The reactor is maintained at a pressure of about 525 psig to 625 psig (3620 kPa to 4309 kPa) and at a temperature in the range of about 140° F. to about 220° F. (about 60° C. to about 104° C.). Reaction heat is removed through the loop wall since much of the reactor is in the form of a double-jacketed pipe. The slurry is allowed to exit the reactor at regular intervals or continuously to a heated low pressure flash vessel, rotary dryer and a nitrogen purge column in sequence for removal of the isobutane diluent and all unreacted monomer and comonomers. The resulting hydrocarbon free powder is then compounded for use in various applications.

In another embodiment, the reactor used in the slurry process of the invention is capable of and the process of the invention is producing greater than 2000 lbs of polymer per hour (907 Kg/hr), more preferably greater than 5000 lbs/hr (2268 Kg/hr), and most preferably greater than 10,000 lbs/hr (4540 Kg/hr). In another embodiment the slurry reactor used in the process of the invention is producing greater than 15,000 lbs of polymer per hour (6804 Kg/hr), preferably greater than 25,000 lbs/hr (11,340 Kg/hr) to about 100,000 lbs/hr (45,500 Kg/hr).

In another embodiment in the slurry process of the invention the total reactor pressure is in the range of from 400 psig (2758 kPa) to 800 psig (5516 kPa), preferably 450 psig (3103 kPa) to about 700 psig (4827 kPa), more preferably 500 psig (3448 kPa) to about 650 psig (4482 kPa), most preferably from about 525 psig (3620 kPa) to 625 psig (4309 kPa).

In yet another embodiment in the slurry process of the invention, the concentration of predominant monomer in the reactor liquid medium is in the range of from about 1 to 10 weight percent, preferably from about 2 to about 7 weight percent, more preferably from about 2.5 to about 6 weight percent, most preferably from about 3 to about 6 weight percent.

Another process of the invention is where the process, preferably a slurry or gas phase process is operated in the absence of or essentially free of any scavengers, such as triethylaluminum, trimethylaluminum, tri-isobutylaluminum and tri-n-hexylaluminum and diethyl aluminum chloride, dibutyl zinc and the like. This process is described in PCT publication WO 96/08520 and U.S. Pat. No. 5,712,352.

In another embodiment the process is run with scavengers. Typical scavengers include trimethyl aluminum, tri-isobutyl aluminum and an excess of alumoxane or modified alumoxane.

Homogeneous or Solution Phase Polymerization

The catalysts described herein may be used advantageously in homogeneous solution processes. Generally this involves polymerization in a continuous reactor in which the polymer formed and the starting monomer and comonomers, and catalyst materials supplied, are agitated to reduce or avoid concentration gradients. Suitable processes included, are performed above the melting point of the polymers at high pressure at from 10 to 3000 bar (100-30,000 MPa).

Each of these processes may also be employed in single, parallel or series reactors. The liquid processes comprise contacting olefin monomer and comonomers with the above described catalyst system in a suitable diluent or solvent and allowing said monomers to react for a sufficient time to produce the desired polymers. Hydrocarbyl solvents are suitable, both aliphatic and aromatic, alkanes, such as hexane, are preferred.

Generally speaking, the polymerization reaction temperature can vary from 40° C. to 250° C. Preferably the polymerization reaction temperature will be from 60° C. to 220°. The pressure can vary from about 1 mm Hg to 2500 bar (25,000 MPa), preferably from 0.1 bar to 1600 bar (1-16,000 MPa), most preferably from 1.0 to 500 bar (10-5000 MPa).

The process can be carried out in a continuous stirred tank reactor, or more than one reactor operated in series or parallel. These reactors may have or may not have internal cooling and the monomer feed may or may not be refrigerated. See the general disclosure of U.S. Pat. No. 5,001,205 for general process conditions. See also, international application WO 96/33227 and WO 97/22639. All documents are incorporated by reference for description of polymerization processes, metallocene selection and useful scavenging compounds.

Formulations of the Polymers

The polymer compositions of this invention may be used in any application where polypropylene is used, such as molded or extruded articles, such as films, fibers, injection-molded articles, blow-molded articles, thermoformed articles, adhesive formulations, wovens, non-wovens, blends with other polymers for impact modification, and the like.

Of course, it should be understood that a wide range of changes and modifications can be made to the embodiments described above. It is therefore intended that the foregoing description illustrates rather than limits this invention, and that it is the following claims, including all equivalents, which define this invention. For example, one skilled in the art would be familiar with the use of additives to enhance a specific property, or those which may be present as a result of processing of the individual components.

Additives which may be incorporated include, for example, fire retardants, antioxidants, plasticizers, pigments, vulcanizing or curative agents, vulcanizing or curative accelerators, cure retarders, processing aids, flame retardants, tackifying resins, dyes, waxes, heat stabilizers, light stabilizers, anti-block agents, processing aids, and any combinations thereof. These compounds may include fillers and/or reinforcing materials (including granular, fibrous, or powder-like). These include carbon black, clay, talc, calcium carbonate, mica, silica, silicate, titanium dioxide, barium sulfate, sand, glass beads, mineral aggregates, and combinations comprising at least one of the foregoing.

Other optional components that may be combined with the polymer product of this invention are plasticizers or another additives such as oils, surfactants, fillers, color masterbatches, and the like. Preferred plasticizers include mineral oils, polybutenes, phthalates and the like. Particularly preferred plasticizers include phthalates such as diisoundecyl phthalate (DIUP), diisononylphthalate (DINP), dioctylphthalates (DOP), and the like. Other optional components that may be combined with the polymer product of this invention are low molecular weight products such as wax, oil or low Mn polymer, (low meaning below Mn of 5000, preferably below 4000, more preferably below 3000, even more preferably below 2500).

In another embodiment the copolymer produced by this invention may be blended with elastomeric polymers. In a preferred embodiment, elastomers are blended with the polymer composition produced by this invention to form rubber toughened compositions. In a particularly preferred embodiment the rubber toughened composition is a two (or more) phase system where the rubber is a discontinuous phase and the polymer composition is a continuous phase. Examples of some elastomers include one or more of the following: ethylene propylene rubber, ethylene propylene diene monomer rubber, neoprene rubber, styrenic block copolymer rubbers (including SI, SIS, SB, SBS and the like), ethylene based plastomers etc. This blend may also be combined with tackifiers and other additives as described herein.

In a preferred aspect, the present invention provides food or medical packaging materials or articles, or medical devices, which may be clear and/or resistant to softening at elevated temperature. These are suited for sterilization by high energy radiation by themselves, with their contents, or they have been exposed to radiation sufficient for such sterilization. The present invention provides for a balance of physical properties, clarity, and radiation resistance, any or all of which can be optimized for a wide variety of commercial applications.

Blends comprising the herein described copolymer may also contain a chemical stabilizing additive useful for providing radiation tolerance to polypropylene such as a hindered amine light stabilizer (HALS). Preferred examples of this additive are the 2,2,4,4-tetramethylpiperidine derivatives such as N,N-bis(2,2,6,6-tetramethyl-4-piperidinyl)-1,6-hexanediamine,bis(2,2,6,6-t etramethyl-4-piperidinyl)decanedioate, and the reaction product of dimethyl succinate plus 4-hydroxy-2,2,6,6-tetramethyl-1-piperidine-ethanol sold by Ciba-Geigy Corporation under the tradenames Chimassorb 944LD, Tinuvin 770, and Tinuvin 622LD, respectively. The HALS is employed at 0.01 to 0.5 wt % of the formulation, preferably from 0.02 to 0.25 wt %, and most preferably from 0.03 to 0.15 wt %.

The resistance to oxidative degradation of the formulations may also be enhanced by the presence of a secondary antioxidant such as those of the thiodipropionate ester and the phosphite types. Preferred examples of the thiodipropionates are distearyl thiodipropionate (DSTDP) and dilaurylthiodipropionate (DLTDP), commercially available from Deer Polymer Corporation. Preferred embodiments of the phosphites are tris(2,4-di-t-butylphenyl)phosphite and bis(2,4-di-t-butylphenyl)pentaerythritol diphosphite available as Irgafos 168 from Ciba-Geigy Corporation and Ultranox 626 available from General Electric Specialty Chemicals, respectively. Additives of this class may be optionally included in the subject blends at 0.01 to 0.50 wt % by weight of the formulation. Preferably, if used, they would be added at 0.02-0.25 wt % of the formulation, most preferably at 0.03-0.15 wt % of the formulation.

The additives included for the purpose of providing clarity to the blends of this invention are drawn from the general class of compound known as organic nucleating agents. In this class are a wide variety of chemical compositions, including but not limited to salts of benzoic and other organic acids, salts of partially esterified phosphoric acid, and dibenzylidene sorbitols. Preferred are the dibenzylidene sorbitols for their powerful clarifying effects. Most preferred are bis-4-methylbenzylidene sorbitol and bis-3,4,-dimethylbenzylidene sorbitol which are available from Milliken Chemical Company under the tradenames Millad 3940 and Millad 3988 respectively. When included in the formulations of the subject materials, these clarifying nucleators are used at from 0.05 to 1.0 wt % by weight of the composition, preferably from 0.1 to 0.5 wt %, and most preferably from 0.15 to 0.35 wt %.

In all of the above cases, the additives described may be incorporated into the blends of this invention as part of either of the major polymeric components of the blend or as an additional component added to the blend itself.

With respect to the physical process of producing the blend, sufficient mixing should take place to assure that a uniform blend will be produced prior to conversion into a finished product. Thus, in the cases of injection molding of medical devices, casting and blowing of packaging films, extrusion of tubing, profiles, and the like, simple solid state blends of the pellets serve equally as well as pelletized melt state blends of raw polymer granules, of granules with pellets, or of pellets of the two components since the forming process includes a remelting and mixing of the raw material. In the process of compression molding of medical devices, however, little mixing of the melt components occurs, and a pelletized melt blend would be preferred over simple solid state blends of the constituent pellets and/or granules. Those skilled in the art will be able to determine the appropriate procedure for blending of the polymers to balance the need for intimate mixing of the component ingredients with the desire for process economy.

Useful applications of the processes and materials, articles, and devices include food packaging material comprising: film and a self-supporting multilayered structure which includes: 1) metal foil, 2) cellulosic material, 3) opaque plastic film, or combinations thereof. This, of course includes simple wrapping film, film useful for bubble or blister packing, and the materials useful for producing the containers known as “liquid-boxes” as well as other useful pouches, bottles or hybrid-type containers. The useful food packaging materials may be formed by extrusion, blowing, lamination, or combinations thereof.

Further provided by the processes and applications are medical devices which are suitable for 1) intravenous (IV) use, 2) transport, storage, dispensing, or combinations thereof of medications, 3) surgical use, 4) medical examination, 5) culture growth, preparation, examination, or combinations thereof, 6) other laboratory operations, or 7) combinations thereof.

Such medical devices include such items as 1) IV catheter, probe, expanding device such as an arterial “balloon”, or combinations thereof, 2) IV fluid container or dispenser, IV tubing, IV valve, IV injection port, unit-dose package, syringe or syringe barrel, or combinations thereof, 3) forceps, handle or holder for surgical instruments, surgical probe, curette, clamp or tying device, retractor, biopsy sampler, gowns, drapes, masks, filters, filter membranes, caps, booties, or combinations thereof, 4) speculum, probe, retractor, forceps, scraper, sampler, or combinations thereof, 5) culture dish, culture bottle, cuvette, smear slide, smear or sample container, or combinations thereof.

Further specific examples of useful medical devices which may be made by the practice of our invention include disposable and reusable hypodermic syringes, particularly the barrels and plunger parts. This would, of course, include prefilled hypodermic syringes for drug packaging and delivery as well as ancillary parts of syringes including needle hubs and needle sheaths. This will also include parts for parenteral kits including valves, cannula hubs, connectors, and cannula shields. Parts for catheters are also included, particularly cannula hubs, connectors, and cannula shields. Useful labware may also be produced including test tubes, culture tubes, and centrifuge tubes as well as vacuum blood collection tubes and ancillary parts including needle adapters/holders, and shields as well as drug vials, caps, and seals. Measuring devices such as droppers, eye-droppers, pipettes, and graduated feeding tubes, cylinders, and burets may also be usefully made by the practice of our invention as well as infant or disabled nursers and nurser holders.

Other useful articles and goods may be formed economically by the practice of our invention including: labware, such as roller bottles for culture growth and media bottles, instrumentation sample holders and sample windows; liquid storage containers such as bags, pouches, and bottles for storage and IV infusion of blood or solutions; packaging material including those for any medical device or drugs including unit-dose or other blister or bubble pack as well as for wrapping or containing food preserved by irradiation. Other useful items include medical tubing and valves for any medical device including infusion kits, catheters, and respiratory therapy, as well as packaging materials for medical devices or food which is irradiated including trays, as well as stored liquid, particularly water, milk, or juice, containers including unit servings and bulk storage containers as well as transfer means such as tubing, pipes, and such.

These devices may be made or formed by any useful forming means for forming polyolefins. This will include, at least, molding including compression molding, injection molding, blow molding, and transfer molding; film blowing or casting; extrusion, and thermoforming; as well as by lamination, pultrusion, protrusion, draw reduction, rotational molding, spinbonding, melt spinning, melt blowing; or combinations thereof Use of at least thermoforming or film applications allows for the possibility of and derivation of benefits from uniaxial or biaxial orientation of the radiation tolerant material.

Those skilled in the art will recognize other unnamed applications and processes which fall within the scope of this invention. It is not our intent to exclude such applications and processes which are apparent in light of our description, but merely offer helpful exemplification of our invention.

In an effort to further clarify our invention, we provide a brief history and examples of our own testing. This is provided as exemplification not for limitation.

In an effort to further clarify our invention, we provide a brief history and examples of our own testing. This is provided as exemplification not for limitation.

### EXAMPLES

A series of experiments were conducted to evaluate the radiation tolerance, and other physical properties of the copolymers of this invention. In the examples:
Molecular weight of the copolymers was determined using a Waters 150 C high temperature GPC instrument;
Melting and crystallization parameters were measured using TA Instrument DSC 2920 with a heating and cooling rate of 10° C./min, and the reported melting temperatures were obtained from the second melt;
Young's modulus, yield stress, yield strain, and break strain were determined on an Instron analyzer using compression molded films according to ASTM-D1708; and
Flexural Modulus was measured on injection-molded bars according to ASTM D790.
   Sample Testing

Example 7 was tested in comparison to Comparative Example 8, as described below. Each polymer material tested was injection molded into test parts in an ASTM family mold. In addition, thin films of polymer of about 4 mil thickness were compression molded in a heated press at a temperature of approximately 210° C. for 5-7 min. The sample specimens were exposed to between 0.0 and 99 kGy of Co⁶⁰ irradiation at approximately 6 KGy/hour rate. These samples were then exposed to accelerated aging at 60° C. for 21 days, an aging protocol recognized by one of skill in the art to approximately represent at least 24 months of real time aging. The specimens were then examined by various methods including, the method informally known as “flex-to-failure”, a test favored by the inventors for the determination of embrittlement of polymers following irradiation. The flex to failure test method is completely described in “Method for Evaluating the Gamma Radiation Tolerance of Polypropylene for Medical Device Applications” by R. C. Portnoy and V. R. Cross, a paper published in the Proceedings of the Society of Plastics Engineers 1991 Annual Technical Conference (Society of Plastics Engineers, Brookfield, Conn.). Briefly, the test consists of flexing a standard test specimen derived from the ASTM tensile bar in a three point bending mode as used in the determination of flexural modulus (ASTM D 790-86). The test is continued until a peak load is recorded. The deflection at which this peak load occurs is characteristic of the ductility of the specimen. The lower the deflection that is recorded in irradiated samples, the greater is the embrittlement that has resulted from the irradiation and aging protocol.

### Examples 1-8

Examples 1-7 were prepared as described below. Comparative Example 8 is commercially available under the trade name PP 9074MED which was used as received from ExxonMobil Chemical Company of Houston, Tex., USA. This material is marketed specifically as being useful for radiation resistance, particularly in medical applications.

Polymerization

Examples 1-7 were prepared using polymerization grade propylene, which as used in the reactions, was first purified by passing it through activated basic alumina and molecular sieves. Polymerization was conducted in a 2-liter autoclave reactor. The reactor was typically charged with propylene (400ml) triethylaluminum (TEAL, 1.0 ml of 1M solution in hexane), hydrogen (6.6mmole), and an amount of comonomer (comonomers) as specified in the particular examples. The reactor contents were stirred at 550 RPM, and the catalyst (rac-dimethylsilandiyl bis(2-methyl-4-phenylindenyl)zirconium dimethyl) activated dimethyl anilinium tetrakis(perfluorophenyl)borate and supported on silica, 70 mg, pre-loaded in a catalyst tube) was injected with propylene (100 ml). The reactor was heated to 70° C. and stirring was kept at 550 RPM. After 60 min, the polymerization was stopped by cooling the reactor to 25° C. and the propylene was vented. The polymer was then collected, and dried in a vacuum oven at 80° C. for 12 hours.

Details of the synthesis and characterization of the propylene/4-methyl pentene copolymers of Examples 1-7 are listed in Table 1, Propylene/4-Methyl Pentene Copolymers.

TABLE 1
Propylene/4-Methyl Pentene Copolymers

| Sample | 1 | 2 | 3 | 4 | 5 | 6 | 7 |
|---|---|---|---|---|---|---|---|
| Temp (° C.) | 70 | 70 | 70 | 70 | 70 | 70 | 70 |
| Propylene (ml) | 500 | 500 | 500 | 500 | 500 | 1000 | 1000 |
| TEAL (ml) | 1 | 1 | 1 | 1 | 1 | 1 | 1 |
| H₂ (mmol) | 6.90 | 6.90 | 6.90 | 6.90 | 6.90 | 6.90 | 6.90 |
| 4-methyl | 5 | 5 | 10 | 15 | 20 | 20 | 20 |
| pentene (ml) | | | | | | | |
| Run time (min) | 60 | 60 | 60 | 60 | 60 | 60 | 60 |
| Yield (g) | 95 | 60 | 90 | 32.4 | 37 | 60 | 109 |

GPC Analysis

| | | | | | | | |
|---|---|---|---|---|---|---|---|
| Mn | 78,300 | 77,200 | 70,900 | 68,900 | 78,600 | 83,700 | 87,300 |
| Mw | 145,000 | 170,200 | 130,600 | 124,600 | 141,300 | 161,500 | 166,000 |
| Mz | 237,100 | 282,500 | 200,200 | 191,900 | 202,800 | 225,400 | 265,000 |
| Mw/Mn | 1.92 | 2.20 | 1.84 | 1.81 | 1.80 | 1.93 | 1.90 |
| Mz/Mw | 1.58 | 1.66 | 1.53 | 1.54 | 1.56 | 1.58 | 1.60 |

DSC Analysis

| | | | | | |
|---|---|---|---|---|---|
| Melt (° C.) | 141.8 | 140.9 | 136.5 | 128.4 | 127.6 |
| ΔH_{f} | 88 | 71 | 80 | 63 | 66 |
| Recrys- | 104.9 | 103.4 | 99.5 | 90.8 | 89.8 |
| talization | | | | | |
| Temp. (° C.) | | | | | |

Instron Analysis

| | | | | | |
|---|---|---|---|---|---|
| Young's | 1045.94 (151700) | 943.38 (136825) | 903.91 (131100) | 734.98 (106600) | 662.45 (96080) |
| Modulus | | | | | |
| MPa (psi) | | | | | |
| Yield stress | 30.94 (4488) | 30.39 (4408) | 28.48 (4132) | 24.45 (3547) | 21.66 (3142) |
| MPa (psi)) | | | | | |
| Yield strain | 9 | 9 | 9 | 10 | 10 |
| (%) | | | | | |
| Break strain | 625 | 653 | 648 | 651 | 620 |
| (%) | | | | | |

The radiation tolerance of Example 7 was compared to Comparative Example 8, the data is shown in Tables 2 through 5. Table 2 shows flexural data on injection molded bars of the copolymer.

TABLE 2
Flexural Data on Injection Molded Bars.

| | | | | | |
|---|---|---|---|---|---|
| | Young's | | | | |
| Radiation Dose | Modulus | Stress at Break | | Strain at Break | |
| (kGy) | (MPa) | MPa (psi) | % Decrease | (%) | % Decrease |

Example 7

| | | | | | |
|---|---|---|---|---|---|
| 0 | 1310 | 24.39 (3538) | — | 8.9 | — |
| 33 | 1456 | 27.70 (4017) | +13.5 | 8.0 | −10.1 |
| 66 | 1393 | 27.23 (3950) | +11.6 | 8.5 | −4.5 |
| 99 | 1435 | 27.05 (3923) | +10.9 | 8.4 | −5.6 |

Comparative Example 8

| | | | | | |
|---|---|---|---|---|---|
| 0 | 1442 | 27.95 (4054) | — | 8.1 | — |
| 31.5 | 1452 | 28.74 (4168) | +2.8 | 9.4 | +16 |
| 61.8 | 1406 | 24.68 (3579) | −11.7 | 5.3 | −34.6 |
| 92.2 | 1459 | 17.09 (2478) | −38.9 | 1.8 | −77.8 |

As shown in Table 2, the stress and strain at break in the flexural Comparative Example 8 drops drastically after radiation treatment, whereas the polymer corresponding to Example 7 essentially retains these properties even after radiation treatment.

Example 7 was also evaluated as a compression-molded film according to ASTM-D1708. The data is shown in Table 3, Tensile Data on Compression Molded Films.

TABLE 3
Tensile Data on Compression Molded Films

| | | | |
|---|---|---|---|
| Radiation Dose | Young's Modulus | Stress at Break | Strain at Break |
| (kGy) | MPa (psi) | MPa (psi) | MPa (psi) |

Example 7

| | | | |
|---|---|---|---|
| 0 | (959.73) | 37.25 (5403) | 673 |
| | 139200 | | |
| 33 | (1178.63) | 21.89 (3176) | 355 |
| | 170950 | | |
| 66 | (1203.19) | 23.03 (3341) | 160 |
| | 174512 | | |
| 99 | (1159.67) | 35.19 (5104) | 7 |
| | 168200 | | |

Comparative Example 8

| | | | |
|---|---|---|---|
| 0 | (875.61) | 36.45 (5286) | 762 |
| | 127000 | | |
| 31.5 | * | * | * |
| 61.8 | * | * | * |
| 92.2 | * | * | * |

*Sample was too brittle to measure mechanical properties.

As the data shows, Example 7 retains mechanical strength even after the highest amount of radiation tested. However, Comparative Example 8 does not retain enough mechanical strength to allow testing. In fact, Comparative Example 8 became too brittle to handle, implying gross degradation of physical properties.

The enhanced radiation tolerance of Example 7 is further demonstrated through molecular weight analysis of the polymer both before and after irradiation.

Example 7 of the present invention shows less reduction of molecular weight after being irradiated, which is consistent with the improved retention of mechanical properties demonstrated above in the present invention, as compared to Comparative Example 8. The data is shown in Table 4, Molecular Weight Data.

TABLE 4
Molecular Weight Data

| Parameter | Example 7 | | | | Comparative Example 8 | | | |
|---|---|---|---|---|---|---|---|---|
| Radiation Dose | 0 | 33 | 66 | 99 | 0 | 31.5 | 61.8 | 92.2 |
| (kGy) | | | | | | | | |
| Mn | 84142 | 49123 | 36368 | 27364 | 67092 | 24878 | 12709 | 11001 |
| Mw | 158118 | 98996 | 70878 | 56733 | 164969 | 53152 | 28678 | 25718 |
| Mz | 254447 | 153226 | 108205 | 88110 | 298085 | 83874 | 47391 | 44269 |
| Mw/Mn | 1.88 | 7.02 | 1.95 | 7.07 | 7.46 | 3.14 | 7.26 | 3.34 |
| Mz/Mw | 1.61 | 1.55 | 1.53 | 1.55 | 1.81 | 1.58 | 1.65 | 1.77 |
| Change in | — | −37.39 | −55.17 | −64.12 | — | −67.78 | −82.62 | −84.41 |
| Mw (%) | | | | | | | | |

The data in Table 4 shows the superior radiation tolerance of the present invention, and also supports the belief that radiation causes molecular weight reduction due to radical-induced chain scission.

Accordingly, disclosed herein is:
1a. A copolymer comprising the polymerization product of propylene and a branched olefin, the copolymer comprising:
   about 80 to about 99.9 wt % propylene;
   about 0.1 to about 20 wt % branched olefin; and
   the copolymer having a weight average molecular weigh of about 80,000 to about 800,000 Daltons, wherein a weight average molecular weight of the copolymer after being irradiated at a dosage of at least about 5 kGy is greater than or equal to about 90% the weight average molecular weight of the copolymer prior to being irradiated.
2a. The copolymer of 1a, comprising less than or equal to about 10 wt % linear alpha olefins.
3a. The copolymer of 1a-2a, having a ratio of a weight average molecular weight to a number average molecular weight of less than or equal to about 4, prior to being irradiated.
4a. The copolymer of 1a-3a, having a composition distribution breadth index of greater than or equal to about 40, prior to being irradiated.
5a. The copolymer of 1a-4a, having a Young's Modulus according to ASTM-D1708 of greater than or equal to about 480 MPa, prior to being irradiated.
6a. The copolymer of 1a-5a, having a yield stress according to ASTM-D1708 of greater than or equal to about 17 MPa, prior to being irradiated.
7a. The copolymer of 1a-6a, having a break strain according to ASTM-D1708 of greater than or equal to about 100%, prior to being irradiated.
8a. The copolymer of 1a-7a, having a break strain according to ASTM-D1708 of greater than or equal to about 50%, after being irradiated at a dosage of at least about 5 kGy.
9a. The copolymer of 1a-8a having a break strain after being irradiated at a dosage of at least about 5 kGy, that is greater than or equal to about 90% the break strain of the copolymer prior to being irradiated.
10a. The copolymer of 1a-9a, wherein the branched olefin comprises a branched alpha olefin, a cyclic olefin, an aromatic olefin, a substituted aromatic olefin, or a combination comprising at least one of the foregoing.
11 a. The copolymer of 1a-10a, wherein the branched alpha olefin is represented by the formula:
   H₂C═C(R¹, R²), and wherein R¹ and R² independently represent hydrogen, halogen, or a carbon containing radical subject to the proviso that R¹ and R² collectively comprise at least 2 carbon atoms.
12a. The copolymer of 1a-11a, wherein the branched olefin comprises 3-methyl-1-pentene, 4-methyl-1-pentene, 3-methyl-1-butene, 3,3-dimethyl-1-butene, 4,4-dimethyl-1-hexene, 3-methyl-1-hexene, 4,4-dimethyl-1-pentene, 3-ethyl-pentene, vinylcyclohexane, or a combination comprising at least one of the foregoing.
13a. The copolymer of 1a-12a, having a weight average molecular weight after being irradiated at a dosage of at least about 20 kGy, that is greater than or equal to about 80% the weight average molecular weight of the copolymer prior to being irradiated.
14a. A medical device comprising the copolymer of 1a-13a.
15a. A packaging container comprising the copolymer of 1a-13a.
16a. A copolymer comprising the polymerization product of propylene and a branched olefin, the copolymer comprising:
   about 90 to about 99 wt % propylene;
   about 1 to about 10 wt % of a branched olefin;
   less than or equal to about 5 wt % linear alpha olefin;
   the copolymer further having a weight average molecular weight of about 150,000 to about 600,000 Daltons;
   a ratio of a weight average molecular weight to a number average molecular weigh of less than or equal to about 3;
   a composition distribution breadth index of greater than or equal to about 60;
   a Young's Modulus according to ASTM-D1708 of greater than or equal to about 585 MPa;
   a yield stress according to ASTM-D1708 of greater than or equal to about 20 MPa; and
   a break strain according to ASTM-D1708 of greater than or equal to about 200%, wherein and the copolymer, after being irradiated at a dosage of about 20 kGy has:
   a break strain of greater than or equal to about 100%;
   a break strain of greater than or equal to about 80% the break strain of the copolymer prior to being irradiated at a dosage of about 20 kGy; and
   a weight average molecular weight of greater than or equal to about 80% the weight average molecular weight of the copolymer prior to being irradiated at a dosage of about 20 kGy.
17a. The copolymer of 16a, wherein the branched olefin comprises 3-methyl-1-pentene, 4-methyl-1-pentene, 3-methyl-1-butene, 3,3-dimethyl-1-butene, 4,4-dimethyl-1-hexene, 3-methyl-1-hexene, 4,4-dimethyl-1-pentene, 3-ethyl-pentene, vinylcyclohexane, or a combination comprising at least one of the foregoing.
18a. A process to produce a copolymer of 1a-17a comprising the steps of:
contacting propylene and one or more branched olefins with a metallocene catalyst, and collecting the copolymer.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A copolymer comprising the polymerization product of propylene and a branched olefin, the copolymer comprising:
about 80 to about 99.9 wt % propylene;
about 0.1 to about 20 wt % branched olefin; and
the copolymer having a weight average molecular weigh of about 80,000 to about 800,000 Daltons, wherein a weight average molecular weight of the copolymer after being irradiated at a dosage of at least about 5 kGy is greater than or equal to about 90% the weight average molecular weight of the copolymer prior to being irradiated.

2. The copolymer of claim 1, comprising less than or equal to about 10 wt % linear alpha olefins.

3. The copolymer of claim 1, having a ratio of a weight average molecular weight to a number average molecular weight of less than or equal to about 4, prior to being irradiated.

4. The copolymer of claim 1, having a composition distribution breadth index of greater than or equal to about 40, prior to being irradiated.

5. The copolymer of claim 1, having a Young's Modulus according to ASTM-D1708 of greater than or equal to about 480 MPa, prior to being irradiated.

6. The copolymer of claim 1, having a yield stress according to ASTM-D1708 of greater than or equal to about 17 MPa, prior to being irradiated.

7. The copolymer of claim 1, having a break strain according to ASTM-D1708 of greater than or equal to about 100%, prior to being irradiated.

8. The copolymer of claim 1, having a break strain according to ASTM-D1708 of greater than or equal to about 50%, after being irradiated at a dosage of at least about 5 kGy.

9. The copolymer of claim 7, having a break strain after being irradiated at a dosage of at least about 5 kGy, that is greater than or equal to about 90% the break strain of the copolymer prior to being irradiated.

10. The copolymer of claim 9, wherein the branched olefin comprises a branched alpha olefin, a cyclic olefin, an aromatic olefin, a substituted aromatic olefin, or a combination comprising at least one of the foregoing.

11. The copolymer of claim 10, wherein the branched alpha olefin is represented by the formula:
H₂C═C(R′, R²), and wherein R¹ and R² independently represent hydrogen, halogen, or a carbon containing radical subject to the proviso that R¹ and R² collectively comprise at least 2 carbon atoms.

12. The copolymer of claim 1, wherein the branched olefin comprises 3-methyl-1-pentene, 4-methyl-1-pentene, 3-methyl-1-butene, 3,3-dimethyl-1-butene, 4,4-dimethyl-1-hexene, 3-methyl-1-hexene, 4,4-dimethyl-1-pentene, 3-ethyl-pentene, vinylcyclohexane, or a combination comprising at least one of the foregoing.

13. The copolymer of claim 9, wherein the branched olefin comprises 3-methyl-1-pentene, 4-methyl-1-pentene, 3-methyl-1-butene, 3,3-dimethyl-1-butene, 4,4-dimethyl-1-hexene, 3-methyl-1-hexene, 4,4-dimethyl-1-pentene, 3-ethyl-pentene, vinylcyclohexane, or a combination comprising at least one of the foregoing.

14. The copolymer of claim 1, having a weight average molecular weight after being irradiated at a dosage of at least about 20 kGy, that is greater than or equal to about 80% the weight average molecular weight of the copolymer prior to being irradiated.

15. A medical device comprising the copolymer of claim 1.

16. A packaging container comprising the copolymer of claim 1.

17. A copolymer comprising the polymerization product of propylene and a branched olefin, the copolymer comprising:
about 90 to about 99 wt % propylene;
about 1 to about 10 wt % of a branched olefin;
less than or equal to about 5 wt % linear alpha olefin;
the copolymer further having a weight average molecular weight of about 150,000 to about 600,000 Daltons;
a ratio of a weight average molecular weight to a number average molecular weigh of less than or equal to about 3;
a composition distribution breadth index of greater than or equal to about 60;
a Young's Modulus according to ASTM-D1708 of greater than or equal to about 585 MPa;
a yield stress according to ASTM-D1708 of greater than or equal to about 20 MPa; and
a break strain according to ASTM-D1708 of greater than or equal to about 200%, wherein and the copolymer, after being irradiated at a dosage of about 20 kGy has:
a break strain of greater than or equal to about 100%;
a break strain of greater than or equal to about 80% the break strain of the copolymer prior to being irradiated at a dosage of about 20 kGy; and
a weight average molecular weight of greater than or equal to about 80% the weight average molecular weight of the copolymer prior to being irradiated at a dosage of about 20 kGy.

18. The copolymer of claim 17, wherein the branched olefin comprises 3-methyl-1-pentene, 4-methyl-1-pentene, 3-methyl-1-butene, 3,3-dimethyl-1-butene, 4,4-dimethyl-1-hexene, 3-methyl-1-hexene, 4,4-dimethyl-1-pentene, 3-ethyl-pentene, vinylcyclohexane, or a combination comprising at least one of the foregoing.

19. A process to produce a copolymer comprising the steps of:
contacting propylene and one or more branched olefins with a metallocene catalyst, and collecting the copolymer, wherein the copolymer comprises about 80 to about 99.9 wt % propylene; about 0.1 to about 20 wt % branched olefin,
wherein the copolymer has a weight average molecular weigh of about 80,000 to about 800,000 Daltons, and wherein after the copolymer has been irradiated at a dosage of at least about 5 kGy to produce an irradiated copolymer, the irradiated copolymer has a weight average molecular weight greater than or equal to about 90% the weight average molecular weight of the copolymer prior to being irradiated at a dosage of at least about 5 kGy.

20. The process of claim 19, wherein a break strain of the irradiated copolymer is greater than or equal to about 100% according to ASTM-D1708, and wherein the break strain of the irradiated copolymer is greater than or equal to about 90% the break strain of the copolymer prior to being irradiated at a dosage of at least about 5 kGy.
